(19) United States
(12) Patent Application Publication
(10) Pub. No.: US 2025/0386117 A1
(43) Pub. Date: Dec. 18, 2025

(54) SOLID-STATE IMAGING ELEMENT, IMAGING DEVICE, AND METHOD OF CONTROLLING SOLID-STATE IMAGING ELEMENT

(71) Applicant: SONY SEMICONDUCTOR SOLUTIONS CORPORATION, KANAGAWA (JP)

(72) Inventor: HIROSHI KATAYAMA, TOKYO (JP)

(21) Appl. No.: 18/876,328

(22) PCT Filed: Apr. 28, 2023
(86) PCT No.: PCT/JP2023/016840

§ 371 Date: Dec. 18, 2024

(30) Foreign Application Priority Data
Jun. 27, 2022 (JP) 2022-102889

(51) Int. Cl. H04N 25/65; G06V 20/56; H04N 25/616; H04N 25/78

(52) U.S. Cl. CPC H04N 25/65; H04N 25/616; H04N 25/78; G06V 20/56

(57) ABSTRACT

Accuracy is improved in a solid-state imaging element that performs image recognition by convolution integration. In a pixel array section, a plurality of pixels each generating and holding an analog pixel signal is arranged in a two-dimensional grid pattern. A plurality of integration circuits time-integrates the pixel signal held in each of a predetermined number of pixels arranged in a vertical direction among the plurality of pixels and outputs an integration signal. An analog-to-digital converter analog-adds the integration signal of each of the plurality of integration circuits and converts the analog-added integration signal into a digital signal.

### TECHNICAL FIELD

The present technology relates to a solid-state imaging element. Specifically, the present technology relates to a solid-state imaging element that performs convolution integration, an imaging device, and a method of controlling a solid-state imaging element.

### BACKGROUND ART

In recent years, with the development of artificial intelligence (AI) technology, the accuracy of image recognition is significantly improved, and there is an increasing demand for image recognition processing in applications such as factory automation (FA) and monitoring. In particular, for the purpose of use in edge AI, attention has been paid to a technique of providing a circuit that performs convolution integration in a solid-state imaging element to achieve improvement in processing speed and reduction in power cost. For example, a solid-state imaging element has been proposed in which an arithmetic circuit including a pair of capacitive elements for each column and a pixel to which any one of filter coefficients +1, 0, and −1 is applied are provided (See, for example, Non-Patent Document 1.). A charge of a pixel having a filter coefficient of +1 is accumulated in one of the pair of capacitive elements, a charge of a pixel having a filter coefficient of −1 is accumulated in the other of the pair of capacitive elements, and the arithmetic circuit performs analog addition of a difference between currents of these capacitive elements column by column. Such an analog circuit realizes convolution integration.

### CITATION LIST

### Non-Patent Document

Non-Patent Document 1: Martin Lefebvre, et al., A 0.2-to-3. 6TOPS/W Programmable Convolutional Imager SoC with In-Sensor Current-Domain Ternary-Weighted MAC Operations for Feature Extraction and Region-of-Interest Detection, 2021 ISSCC.

### SUMMARY OF THE INVENTION

### Problems to be Solved by the Invention

In the above-described conventional technique, convolution integration is performed by an analog circuit to improve processing speed. However, in the above-described solid-state imaging element, since the filter coefficients are limited to +1, 0, and −1, the accuracy of image recognition may be insufficient. Furthermore, since the arithmetic circuit performs analog addition of the difference column by column, the processing speed becomes slow, and there is a possibility that accuracy is insufficient when a moving subject is imaged.

The present technology has been made in view of such a situation, and an object thereof is to improve accuracy in a solid-state imaging element that performs image recognition by convolution integration.

### Solutions to Problems

The present technology has been made to solve the above-described problems, and a first aspect thereof is a solid-state imaging element including: a pixel array section in which a plurality of pixels each generating and holding an analog pixel signal is arranged in a two-dimensional grid pattern; a plurality of integration circuits that time-integrates the pixel signal held in each of a predetermined number of pixels arranged in a vertical direction among the plurality of pixels and outputs an integration signal; and an analog-to-digital converter that analog-adds the integration signal of each of the plurality of integration circuits to convert the analog-added integration signal into a digital signal, and a control method thereof. This brings about an effect that the accuracy is improved when the image recognition processing is performed.

Furthermore, in the first aspect, an integration time for each pixel of the integration circuits may include a time according to an absolute value of a filter coefficient corresponding to the pixel. This brings about an effect that a product-sum operation of the pixel signal and the filter coefficient is performed.

Furthermore, in the first aspect, the pixel signal may include a predetermined reset level and a signal level according to an exposure amount, and the pixel may output the reset level and the signal level in a predetermined order in a case where a sign of the filter coefficient is positive, and output the reset level and the signal level in an order reverse to the predetermined order in a case where the sign of the filter coefficient is negative. This brings about an effect that the sign of the filter coefficient is reflected in a sign of a difference between the reset level and the signal level.

Furthermore, in the first aspect, the plurality of integration circuits may include first and second integration circuits, and the analog-to-digital converter may include: a first capacitive element including one end connected to the first integration circuit; a second capacitive element including one end connected to the second integration circuit; a comparator including two input terminals, one of the two input terminals being connected to another end of each of the first and second capacitive elements; and a counter that counts a count value over a period until an output signal of the comparator is inverted. This brings about an effect that the signal obtained by analog-adding the integral signal is converted into a digital signal.

Furthermore, in the first aspect, the analog-to-digital converter may further include a connection switch that connects the another end of the first capacitive element and the another end of the second capacitive element according to a predetermined switching signal. This brings about an effect that a size of a filter in a horizontal direction is variable.

Furthermore, in the first aspect, each of the pixels may include a photodiode in which a charge storage region is embedded in a predetermined semiconductor substrate. This brings about an effect of improving image quality in a dark place.

Furthermore, in the first aspect, the pixel signal may include a predetermined reset level and a signal level according to an exposure amount, and each of the pixels may include: first and second capacitive elements; a pre-stage circuit that sequentially generates the reset level and the signal level and causes the first and second capacitive elements to hold the reset level and the signal level, respectively; a first post-stage circuit that reads and outputs the reset level held in the first capacitive element; and a second post-stage circuit that reads and outputs the signal level held in the second capacitive element. This brings about an effect of improving a reading speed.

Furthermore, in the first aspect, the pixel signal may include a predetermined reset level and a signal level according to an exposure amount, and each of the pixels may include: first and second capacitive elements; a pre-stage circuit that sequentially generates the reset level and the signal level and causes the first and second capacitive elements to hold the reset level and the signal level, respectively; a selection circuit that sequentially performs control to connect one of the first and second capacitive elements to a predetermined post-stage node, control to disconnect both the first and second capacitive elements from the post-stage node, and control to connect another of the first and second capacitive elements to the post-stage node; a post-stage reset transistor that initializes a level of the post-stage node when both the first and second capacitive elements are disconnected from the post-stage node; and a post-stage circuit that sequentially reads the reset level and the signal level from the first and second capacitive elements via the post-stage node and outputs the reset level and the signal level. This brings about an effect of reducing kTC noise.

Furthermore, a second aspect of the present technology is an imaging device including: a pixel array section in which a plurality of pixels each generating and holding an analog pixel signal is arranged in a two-dimensional grid pattern; a plurality of integration circuits that time-integrates the pixel signal held in each of a predetermined number of pixels arranged in a vertical direction among the plurality of pixels and outputs an integration signal; an analog-to-digital converter that adds the integration signal of each of the plurality of integration circuits to convert the added integration signal into a digital signal, and an image recognition section that performs predetermined image recognition processing using the digital signal. This brings about an effect of improving the accuracy of the image recognition processing.

### BRIEF DESCRIPTION OF DRAWINGS

FIG. 1 is a block diagram illustrating a configuration example of an imaging device in a first embodiment of the present technology.

FIG. 2 is a block diagram illustrating a configuration example of a solid-state imaging element according to the first embodiment of the present technology.

FIG. 3 is a circuit diagram illustrating a configuration example of a pixel according to the first embodiment of the present technology.

FIG. 4 is a circuit diagram illustrating a configuration example of a pixel of a stacked structure according to the first embodiment of the present technology.

FIG. 5 is a block diagram illustrating a configuration example of a load MOS circuit block and a column signal processing circuit according to the first embodiment of the present technology.

FIG. 6 is a circuit diagram illustrating a configuration example of an integration circuit and an ADC according to the first embodiment of the present technology.

FIG. 7 is an example of an overall view of a solid-state imaging element according to the first embodiment of the present technology.

FIG. 8 is a block diagram illustrating a configuration example of the solid-state imaging element and a DSP circuit according to the first embodiment of the present technology.

FIG. 9 is an example of an overall view of a solid-state imaging element in a comparative example.

FIG. 10 is a timing chart illustrating an example of a global shutter operation according to the first embodiment of the present technology.

FIG. 11 is a timing chart illustrating an example of a first auto-zero operation and a first integration operation according to the first embodiment of the present technology.

FIG. 12 is a diagram illustrating an example of a state of the solid-state imaging element within a first auto-zero period according to the first embodiment of the present technology.

FIG. 13 is a diagram illustrating an example of a state of the solid-state imaging element within a first integration period according to the first embodiment of the present technology.

FIG. 14 is a timing chart illustrating an example of a second integration operation according to the first embodiment of the present technology.

FIG. 15 is a diagram illustrating an example of a state of the solid-state imaging element within a second integration period according to the first embodiment of the present technology.

FIG. 16 is a timing chart illustrating an example of a third integration operation according to the first embodiment of the present technology.

FIG. 17 is a diagram illustrating an example of a state of the solid-state imaging element within a third integration period according to the first embodiment of the present technology.

FIG. 18 is a timing chart illustrating an example of a first reading operation according to the first embodiment of the present technology.

FIG. 19 is a diagram illustrating an example of a state of the solid-state imaging element within a first reading period according to the first embodiment of the present technology.

FIG. 20 is a timing chart illustrating an example of a second auto-zero operation and a fourth integration operation according to the first embodiment of the present technology.

FIG. 21 is a diagram illustrating an example of a state of the solid-state imaging element within a second auto-zero period according to the first embodiment of the present technology.

FIG. 22 is a diagram illustrating an example of a state of the solid-state imaging element within a fourth integration period according to the first embodiment of the present technology.

FIG. 23 is a timing chart illustrating an example of a fifth integration operation according to the first embodiment of the present technology.

FIG. 24 is a diagram illustrating an example of a state of the solid-state imaging element within a fifth integration period according to the first embodiment of the present technology.

FIG. 25 is a timing chart illustrating an example of sixth integration operation according to the first embodiment of the present technology.

FIG. 26 is a diagram illustrating an example of a state of the solid-state imaging element within a sixth integration period according to the first embodiment of the present technology.

FIG. 27 is a timing chart illustrating an example of a second reading operation according to the first embodiment of the present technology.

FIG. 28 is a diagram illustrating an example of a state of the solid-state imaging element within a second reading period according to the first embodiment of the present technology.

FIG. 29 is a diagram illustrating an example of a state of the solid-state imaging element when a filter according to the first embodiment of the present technology is slid in a horizontal direction.

FIG. 30 is a flowchart illustrating an example of an operation of the solid-state imaging element according to the first embodiment of the present technology.

FIG. 31 is a diagram illustrating an example of use of the solid-state imaging element according to the first embodiment of the present technology.

FIG. 32 is a circuit diagram illustrating a configuration example of a column signal processing circuit in a modification of the first embodiment of the present technology.

FIG. 33 is a circuit diagram illustrating a configuration example of an ADC according to a second embodiment of the present technology.

FIG. 34 is a diagram illustrating a configuration example of a photoelectric conversion element according to a third embodiment of the present technology.

FIG. 35 is a circuit diagram illustrating a configuration example of a pixel according to a fourth embodiment of the present technology.

FIG. 36 is a circuit diagram illustrating a configuration example of a column signal processing circuit according to the fourth embodiment of the present technology.

FIG. 37 is a circuit diagram illustrating a configuration example of a pixel according to a fifth embodiment of the present technology.

FIG. 38 is a circuit diagram illustrating a configuration example of a pixel in a first modification of the fifth embodiment of the present technology.

FIG. 39 is a timing chart illustrating an example of a global shutter operation in the first modification of the fifth embodiment of the present technology.

FIG. 40 is a diagram illustrating an example of a stacked structure of a solid-state imaging element in a second modification of the fifth embodiment of the present technology.

FIG. 41 is a circuit diagram illustrating a configuration example of a pixel in the second modification of the fifth embodiment of the present technology.

FIG. 42 is a diagram illustrating an example of a stacked structure of a solid-state imaging element in a third modification of the fifth embodiment of the present technology.

FIG. 43 is a circuit diagram illustrating a configuration example of a pixel according to a sixth embodiment of the present technology.

FIG. 44 is a timing chart illustrating an example of a global shutter operation according to the sixth embodiment of the present technology.

FIG. 45 is a circuit diagram illustrating a configuration example of a pixel according to a seventh embodiment of the present technology.

FIG. 46 is a timing chart illustrating an example of voltage control according to the seventh embodiment of the present technology.

FIG. 47 is a timing chart illustrating an example of a rolling shutter operation according to an eighth embodiment of the present technology.

FIG. 48 is a block diagram illustrating a configuration example of a solid-state imaging element according to a ninth embodiment of the present technology.

FIG. 49 is a circuit diagram illustrating a configuration example of a dummy pixel, a regulator, and a switching section according to the ninth embodiment of the present technology.

FIG. 50 is a timing chart illustrating an example of the operation of the dummy pixel and the regulator in the ninth embodiment of the present technology.

FIG. 51 is a circuit diagram illustrating a configuration example of an effective pixel according to the ninth embodiment of the present technology.

FIG. 52 is a timing chart illustrating an example of a global shutter operation according to the ninth embodiment of the present technology.

FIG. 53 is a diagram for explaining an effect in the ninth embodiment of the present technology.

FIG. 54 is a block diagram illustrating a schematic configuration example of a vehicle control system.

FIG. 55 is an explanatory diagram illustrating an example of an installation position of an imaging section.

### MODE FOR CARRYING OUT THE INVENTION

Hereinafter, modes for carrying out the present technology (hereinafter referred to as embodiments) will be described. The description will be given in the following order.
1. First embodiment (Example in which integration circuit and ADC perform product-sum operation)
2. Second embodiment (Example in which filter size is made variable and integration circuit and ADC perform product-sum operation)
3. Third embodiment (Example in which integration circuit and ADC perform product-sum operation)
4. Fourth embodiment (Example in which photodiode is embedded, and integration circuit and ADC perform product-sum operation)
5. Fifth embodiment (Example of causing first and second capacitive elements to hold pixel signal)
6. Sixth embodiment (Example of adding discharge transistor and causing first and second capacitive elements to hold pixel signal)
7. Seventh embodiment (Example of controlling reset power supply voltage by causing first and second capacitive elements to hold pixel signal)
8. Eighth embodiment (Example of causing first and second capacitive elements to hold pixel signal and performing rolling shutter operation)
9. Ninth embodiment (Example of reducing noise and causing first and second capacitive elements to hold pixel signal)
10. Application example to moving body

### 1. First Embodiment

### [Configuration Example of Imaging Device]

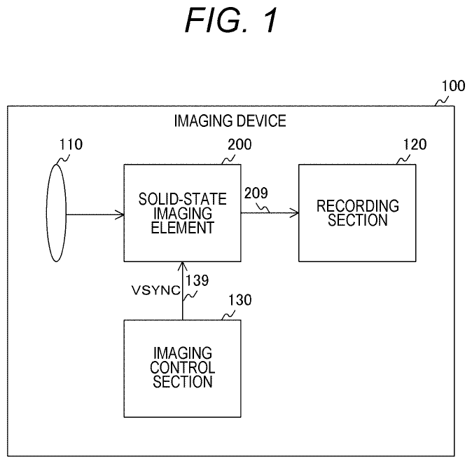

FIG. 1 is a block diagram illustrating a configuration example of an imaging device 100 according to a first embodiment of the present technology. The imaging device 100 is a device that captures image data, and includes an imaging lens 110, a solid-state imaging element 200, a recording section 120, and an imaging control section 130. As the imaging device 100, a digital camera, and an electronic device (a smartphone, a personal computer, or the like) having an imaging function are assumed.

The solid-state imaging element 200 captures image data and performs predetermined processing such as image recognition processing under the control of the imaging control section 130. The solid-state imaging element 200 supplies the processed data to the recording section 120 via a signal line 209.

The imaging lens 110 condenses light and guides the light to the solid-state imaging element 200. The imaging control section 130 controls the solid-state imaging element 200 to capture the image data. For example, the imaging control section 130 supplies an imaging control signal including a vertical synchronization signal VSYNC to the solid-state imaging element 200 via a signal line 139. The recording section 120 records the processed data.

Here, the vertical synchronization signal VSYNC is a signal indicating imaging timing, and a periodic signal of a constant frequency (such as 60 hertz) is used as the vertical synchronization signal VSYNC.

Note that, although the imaging device 100 records the processed data, the data may be transmitted to the outside of the imaging device 100. In this case, an external interface for transmitting the data is further provided. Alternatively, the imaging device 100 may further display a processing result. In this case, a display section is further provided.

### [Configuration Example of Solid-State Imaging Element]

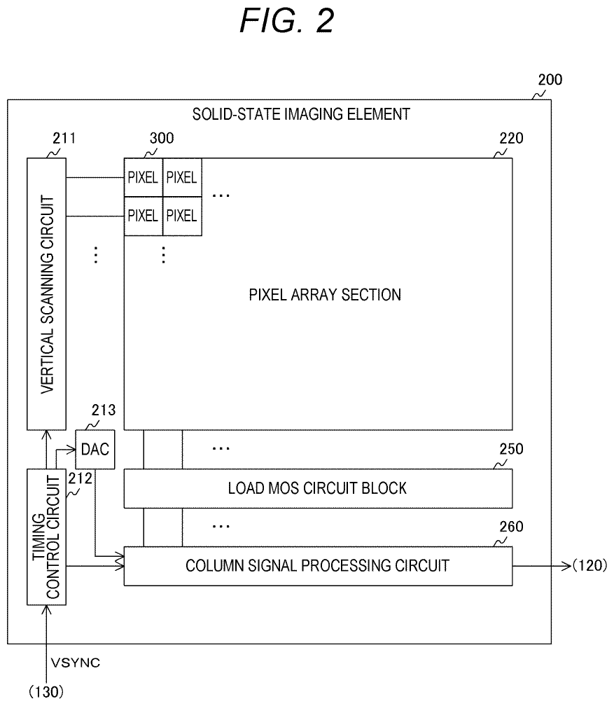

FIG. 2 is a block diagram illustrating a configuration example of the solid-state imaging element 200 according to the first embodiment of the present technology. The solid-state imaging element 200 includes a vertical scanning circuit 211, a pixel array section 220, a timing control circuit 212, a digital to analog converter (DAC) 213, a load MOS circuit block 250, and a column signal processing circuit 260. In the pixel array section 220, a plurality of pixels 300 is arranged in a two-dimensional grid pattern. Furthermore, each circuit in the solid-state imaging element 200 is provided in, for example, a single semiconductor chip.

Hereinafter, a set of pixels 300 arranged in a horizontal direction is referred to as “row”, and a set of pixels 300 arranged in a direction perpendicular to the row is referred to as “column”.

The timing control circuit 212 controls operation timing of each of the vertical scanning circuit 211, the DAC 213, and the column signal processing circuit 260 in synchronization with the vertical synchronization signal VSYNC from the imaging control section 130.

The DAC 213 generates a sawtooth wave-like ramp signal by digital to analog (DA) conversion. The DAC 213 supplies the generated ramp signal to the column signal processing circuit 260.

The vertical scanning circuit 211 sequentially selects and drives rows to output analog pixel signals. Each of the pixels 300 photoelectrically converts incident light to generate the analog pixel signal. This pixel 300 supplies the pixel signal to the column signal processing circuit 260 via the load MOS circuit block 250.

In the load MOS circuit block 250, a MOS transistor that supplies a constant current is provided for each column.

The column signal processing circuit 260 performs signal processing such as analog to digital (AD) conversion processing and correlated double sampling (CDS) processing on the pixel signal for each column. The column signal processing circuit 260 supplies the processed data to the recording section 120.

### [Configuration Example of Pixel]

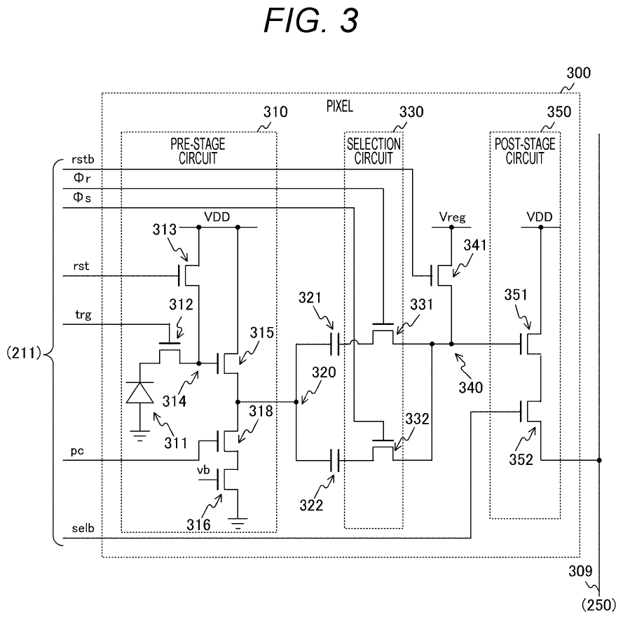

FIG. 3 is a circuit diagram illustrating a configuration example of the pixel 300 according to the first embodiment of the present technology. The pixel 300 includes a pre-stage circuit 310, capacitive elements 321 and 322, a selection circuit 330, a post-stage reset transistor 341, and a post-stage circuit 350.

The pre-stage circuit 310 includes a photoelectric conversion element 311, a transfer transistor 312, a floating diffusion (FD) reset transistor 313, an FD 314, a pre-stage amplification transistor 315, a precharge transistor 318, and a current source transistor 316.

The photoelectric conversion element 311 generates charges by the photoelectric conversion. The transfer transistor 312 transfers the charges from the photoelectric conversion element 311 to the FD 314 in accordance with a transfer signal trg from the vertical scanning circuit 211.

The FD reset transistor 313 extracts the charges from the FD 314 to initialize the FD 314 in accordance with an FD reset signal rst from the vertical scanning circuit 211. The FD 314 accumulates charges, and generates a voltage corresponding to a charge amount. The pre-stage amplification transistor 315 amplifies a level of a voltage of the FD 314, and outputs the amplified voltage to a pre-stage node 320.

Furthermore, the FD reset transistor 313 and the pre-stage amplification transistor 315 have their respective sources connected to a power supply voltage VDD.

The precharge transistor 318 opens and closes a path between the pre-stage node 320 and the current source transistor 316 in accordance with a control signal PC from the vertical scanning circuit 211. For example, immediately after a reset level is held in the capacitive element 321, the vertical scanning circuit 211 turns off the precharge transistor 318 by the control signal PC. As a result, it is possible to prevent charges from being extracted from the capacitive elements 321 and 322. The current source transistor 316 supplies a current id1 according to a bias voltage vb.

The capacitive elements 321 and 322 have their respective one ends commonly connected to the pre-stage node 320 and have their respective other ends connected to the selection circuit 330. Note that the capacitive elements 321 and 322 are examples of first and second capacitive elements recited in the claims.

The selection circuit 330 includes a selection transistor 331 and a selection transistor 332. The selection transistor 331 opens and closes a path between the capacitive element 321 and a post-stage node 340 in accordance with a selection signal Φr from the vertical scanning circuit 211. The selection transistor 332 opens and closes a path between the capacitive element 322 and the post-stage node 340 in accordance with a selection signal Φs from the vertical scanning circuit 211.

The post-stage reset transistor 341 initializes a level of the post-stage node 340 to a predetermined potential Vreg in accordance with a post-stage reset signal rstb from the vertical scanning circuit 211. A potential (for example, a potential lower than VDD) different from VDD is set as the potential Vreg.

The post-stage circuit 350 includes a post-stage amplification transistor 351, and a post-stage selection transistor 352. The post-stage amplification transistor 351 amplifies the level of the post-stage node 340. The post-stage selection transistor 352 outputs a signal at the level amplified by the post-stage amplification transistor 351 to a vertical signal line 309 as a pixel signal in accordance with a post-stage selection signal selb from the vertical scanning circuit 211.

Note that, for example, n-channel metal oxide semiconductor (nMOS) transistors are used as various transistors (the transfer transistor 312 and the like) in the pixel 300.

The vertical scanning circuit 211 supplies the high-level FD reset signal rst and the high-level transfer signal trg to all the pixels at the start of exposure. Therefore, the photoelectric conversion element 311 is initialized. Hereinafter, this control is referred to as “PD reset”.

Then, the vertical scanning circuit 211 supplies the high-level FD reset signal rst over a pulse period while setting the post-stage reset signal rstb and the selection signal or to the high level for all the pixels immediately before the end of exposure. Therefore, the FD 314 is initialized, and a level corresponding to the level of the FD 314 at that time is held in the capacitive element 321. This control is hereinafter referred to as “FD reset”.

The level of the FD 314 at the time of FD reset and a level corresponding to the level of the FD 314 (the level held in the capacitive element 321 and the level of the vertical signal line 309) are hereinafter collectively referred to as “P-phase” or “reset level”.

At the end of exposure, the vertical scanning circuit 211 supplies the high-level transfer signal trg over the pulse period while setting the post-stage reset signal rstb and the selection signal Φs to the high level for all the pixels. Therefore, signal charges corresponding to an exposure amount are transferred to the FD 314, and a level corresponding to the level of the FD 314 at that time is held in the capacitive element 322.

The level of the FD 314 at the time of signal charge transfer and a level corresponding to the level of the FD 314 (the level held in the capacitive element 322 and the level of the vertical signal line 309) are hereinafter collectively referred to as “D-phase” or “signal level”.

The exposure control of simultaneously starting and ending the exposure for all the pixels in this manner is called a global shutter method. Under this exposure control, the pre-stage circuits 310 of all the pixels sequentially generate the reset level and the signal level. The reset level is held in the capacitive element 321, and the signal level is held in the capacitive element 321.

After the end of exposure, the vertical scanning circuit 211 sequentially selects a row, and sequentially outputs the reset level and the signal level of the row. For example, it is assumed that the reset level and the signal level are output in this order.

In this case, the vertical scanning circuit 211 supplies a high-level selection signal ør over a predetermined period while setting the FD reset signal rst and the post-stage selection signal selb of the selected row to the high level. As a result, the capacitive element 321 is connected to the post-stage node 340, and the reset level is output.

After outputting the reset level, the vertical scanning circuit 211 supplies the high-level post-stage reset signal rstb over the pulse period while keeping the FD reset signal rst and the post-stage selection signal selb of the selected row at the high level. As a result, the level of the post-stage node 340 is initialized. At this time, both the selection transistor 331 and the selection transistor 332 are in an open state, and the capacitive elements 321 and 322 are disconnected from the post-stage node 340.

After the initialization of the post-stage node 340, the vertical scanning circuit 211 supplies the high-level selection signal Φs over a predetermined period while keeping the FD reset signal rst and the post-stage selection signal selb of the selected row at the high level. As a result, the other of the capacitive elements 322 is connected to the post-stage node 340, and the signal level is output.

When the vertical scanning circuit 211 supplies the selection signal Φr at the high level next to the selection signal Φs at the high level, the pixel 300 can also output the signal level and the reset level in this order.

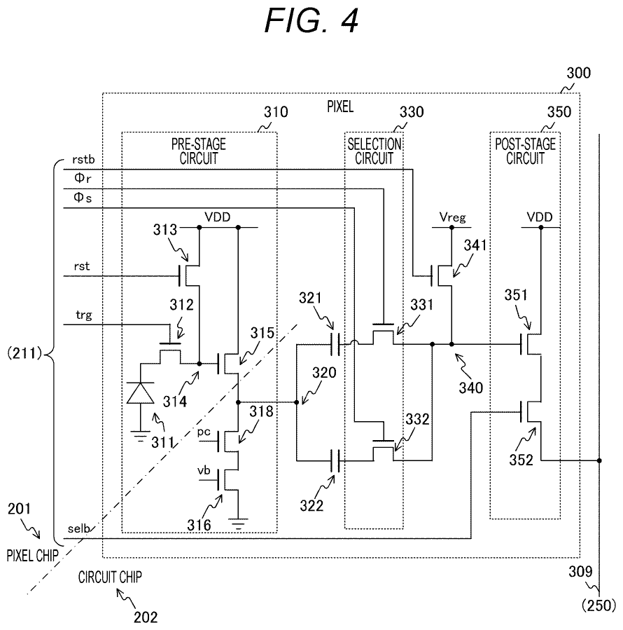

Note that, as illustrated in FIG. 4, the circuits in the solid-state imaging element 200 can be dispersedly disposed on a pixel chip 201 and a circuit chip 202 having a stacked structure. In this case, for example, the photoelectric conversion element 311, the transfer transistor 312, the FD reset transistor 313, the FD 314, and the pre-stage amplification transistor 315 are disposed in the pixel chip 201, and the remaining elements and circuits are disposed in the circuit chip 202.

### [Configuration Example of Column Signal Processing Circuit]

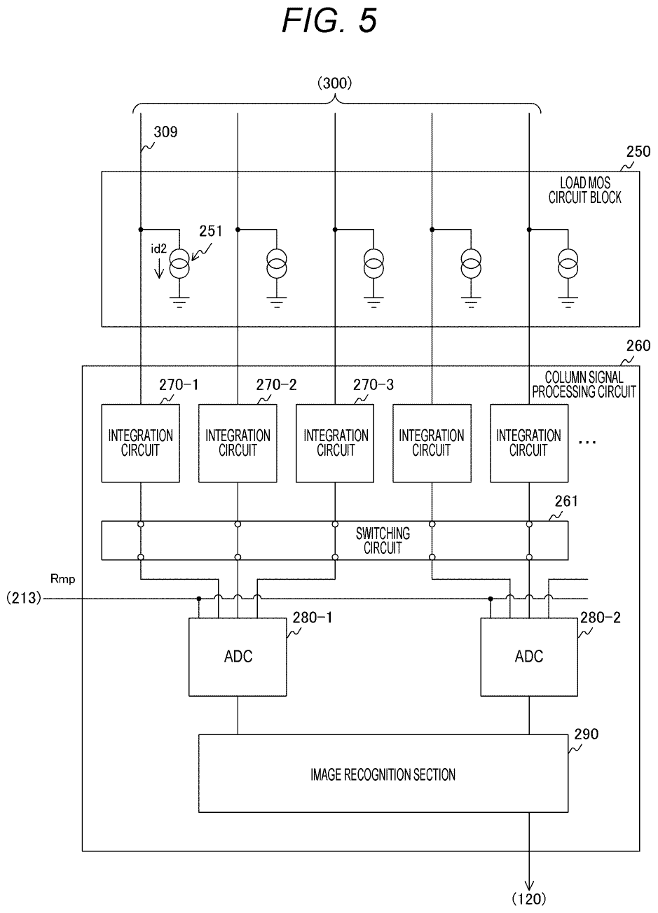

FIG. 5 is a block diagram illustrating a configuration example of the load MOS circuit block 250 and the column signal processing circuit 260 according to the first embodiment of the present technology.

In the load MOS circuit block 250, the vertical signal line 309 is wired for each column. When the number of columns is M (M is an integer), M vertical signal lines 309 are wired. Furthermore, a load MOS transistor 251 that supplies a constant current id2 is connected to each of the vertical signal lines 309.

In the column signal processing circuit 260, a plurality of integration circuits such as the integration circuits 270-1, 270-2, and 270-3, a switching circuit 261, a plurality of ADCs such as the ADCs 280-1 and 280-2, and an image recognition section 290 are disposed. Each of the integration circuit is disposed for each column, and each of the ADCs is disposed for every K columns when the size of the filter to be applied in the horizontal direction is K (K is an integer) columns. In the drawing, the ADCs are disposed every three columns.

Here, the filter is an array of filter coefficients to be multiplied by a pixel signal for each of the plurality of pixels, and is also referred to as a kernel.

The integration circuit 270-1 time-integrates respective pixel signals of the J pixels in the corresponding column with the vertical size of the filter to be applied as J (J is an integer) rows. The integration time for each pixel of the integration circuit 270-1 is a time corresponding to an absolute value of the filter coefficient corresponding to the pixel. For example, the integration time of the pixel having the filter coefficient of “−2” is set to twice the integration time of the pixel having the filter coefficient of “+1”. The integration circuit 270-1 supplies an integration signal to the switching circuit 261. Note that the configurations of the integration circuits 270-2 and 270-3 are similar to those of the integration circuit 270-1.

The switching circuit 261 switches an output destination of each integration circuit on the basis of an application range of the filter. It is assumed that a filter is applied to three columns corresponding to the integration circuits 270-1, 270-2, and 270-3. In this case, for example, the switching circuit 261 sets the output destination of these integration circuits to the ADC 280-1. Then, in a case where the filter is slid rightward by one column, the switching circuit 261 switches the output destination of the integration circuits 270-2 and 270-3 to the ADC 280-2.

The ADC 280-1 analog-adds the respective integration signals of the plurality of integration circuits to convert the signals into digital signals. The ADC 280-1 supplies the digital signal to the image recognition section 290. Note that the configuration of the ADC 280-2 is similar to that of the ADC 280-1.

The image recognition section 290 performs image recognition processing using the digital signal from each ADC such as the ADC 280-1. The image recognition section 290 outputs the processed data to the recording section 120.

### [Configuration Examples of Integration Circuit and ADC]

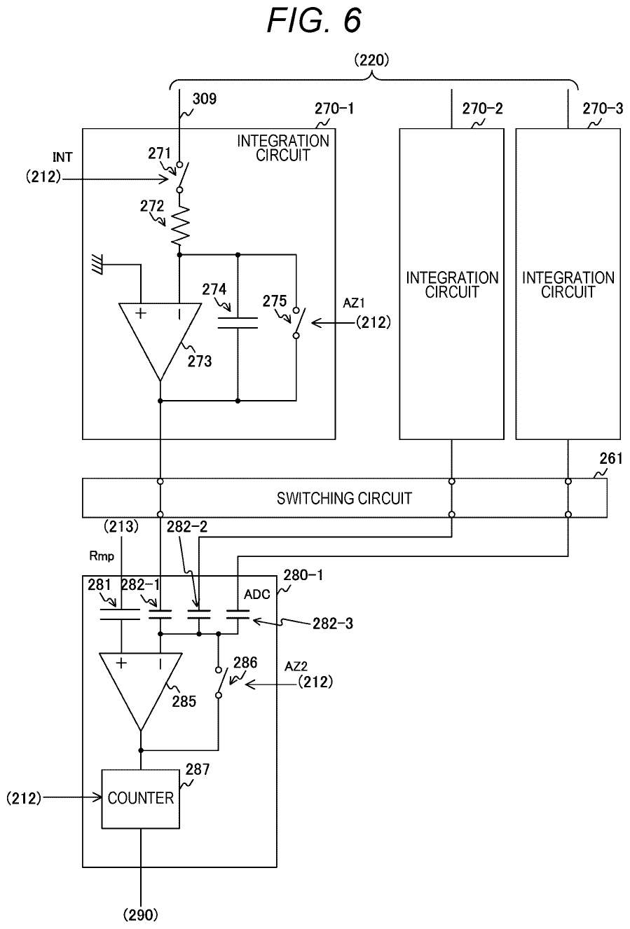

FIG. 6 is a circuit diagram illustrating a configuration example of the integration circuit 270-1 and the ADC 280-1 according to the first embodiment of the present technology. The integration circuit 270-1 includes an input switch 271, a resistive element 272, an operational amplifier 273, a capacitive element 274, and an auto-zero switch 275.

The input switch 271 opens and closes a path between the vertical signal line 309 of the corresponding column and the resistive element 272 in accordance with a control signal INT from the timing control circuit 212. The resistive element 272 is inserted between the input switch 271 and an inverting input terminal (−) of the operational amplifier 273. Furthermore, a non-inverting input terminal (+) of the operational amplifier 273 is grounded. The capacitive element 274 is inserted between a connection node of the input switch 271 and the resistive element 272 and an output terminal of the operational amplifier 273.

The auto-zero switch 275 opens and closes a path between the connection node of the input switch 271 and the resistive element 272 and the output terminal of the operational amplifier 273 according to a control signal AZ1 from the timing control circuit 212.

With the circuit configuration illustrated in the drawing, it is possible to time-integrate the plurality of pixel signals in the corresponding column. The integration time can be adjusted by controlling the time during which the input switch 271 is in a closed state with the control signal INT. The integration time for each pixel is set to a time corresponding to an absolute value of the filter coefficient corresponding to the pixel.

Assuming that the size of the filter is 3 rows×3 columns, each of the integration circuits 270-1, 270-2, and 270-3 time-integrates the pixel signals of three pixels in the corresponding column, and supplies the integration signal to the ADC 280-1 via the switching circuit 261.

The ADC 280-1 includes capacitive elements 281, 282-1, 282-2, and 282-3, a comparator 285, an auto-zero switch 286, and a counter 287. The capacitive element 281 is inserted between the DAC 213 and a non-inverting input terminal (+) of the comparator 285. One end of each of the capacitive elements 282-1 to 282-3 is connected to different integration circuits. For example, one end of the capacitive element 282-1 is connected to the integration circuit 270-1 via the switching circuit 261, and one end of the capacitive element 282-2 is connected to the integration circuit 270-2 via the switching circuit 261. One end of the capacitive element 282-3 is connected to the integration circuit 270-3 via the switching circuit 261. Furthermore, the other ends of the capacitive elements 282-1 to 282-3 are commonly connected to an inverting input terminal (−) of the comparator 285. The capacitance values of the capacitive elements 282-1 to 282-3 are substantially the same. The capacitance value of the capacitive element 281 substantially matches the sum of the capacitance values of the capacitive elements 282-1 to 282-3.

The comparator 285 compares a ramp signal Rmp from the DAC 213 with a signal obtained by analog-adding the respective integration signals of the integration circuits 270-1 to 270-3. The comparator 285 outputs a comparison result to the counter 287.

The auto-zero switch 286 opens and closes a path between the inverting input terminal (−) and an output terminal of the comparator 285 in accordance with a control signal AZ2 from the timing control circuit 212.

The counter 287 counts a count value over a period until the comparison result of the comparator 285 is inverted. The counter 287 supplies a digital signal indicating the count value to the image recognition section 290. Furthermore, the counter 287 corresponds to both up counting and down counting, and the timing control circuit 212 can control whether to perform up counting or down counting.

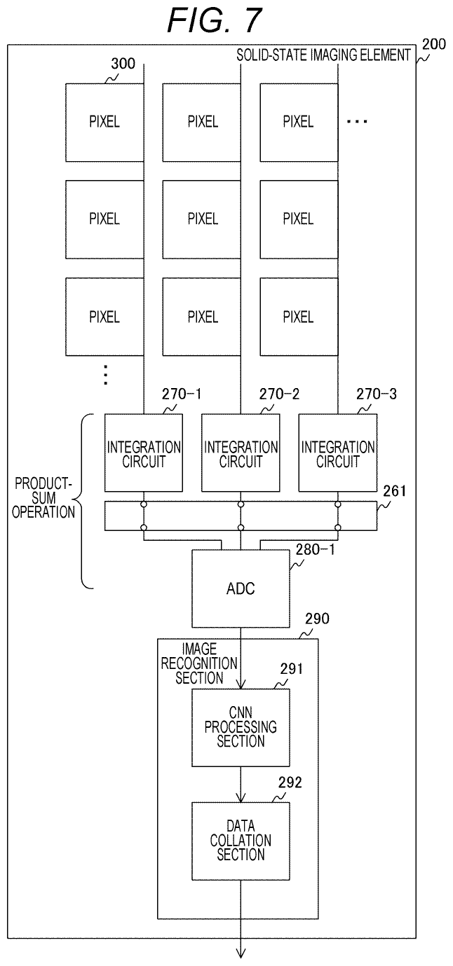

FIG. 7 is an example of an overall view of the solid-state imaging element 200 according to the first embodiment of the present technology.

The plurality of pixels arranged in a two-dimensional grid pattern generates and holds analog pixel signals, respectively. Each of the pixel signals includes a reset level and a signal level corresponding to an exposure amount. Each of the pixels holds the reset level and the signal level, and sequentially outputs the reset level and the signal level.

Here, the size of the filter is defined as J rows×K columns. Of the J rows×K columns to which the filter is applied, a signal to be output first among the reset level and signal level of the j-th row and k-th column is denoted as S1_[j, k], and a signal to be output next is denoted as S2_[j, k]. j is an integer of 0 to J−1, and k is an integer of 0 to K−1. Furthermore, the integration time according to the absolute value of the filter coefficient corresponding to the j-th row and the k-th column is defined as t_[j, k].

The integration circuit in the kth column time-integrates the respective pixel signals (reset level or signal level) of the J pixels in the column. The ADC 280-1 analog-adds the integration signal of each column to convert the analog-added integration signal into a digital signal. The counter in the ADC 280-1 counts up when converting the analog signal corresponding to S1_[j, k] and counts down when converting the analog signal corresponding to S2_[j, k]. As a result, CDS processing of obtaining a difference (in other words, a net signal level) between the reset level and the signal level is realized. Note that, although the ADC performs both the AD conversion and the CDS processing, a configuration may be employed in which a CDS circuit is added at a subsequent stage, the ADC performs only the AD conversion, and the CDS circuit performs the CDS processing.

Then, the ADC 280-1 outputs a digital signal indicating the count value. The digital signal Convd is expressed by the following convolution integration.

$$\begin{matrix}[ Mathematical formula 1 ] & \\ Convd = {\sum }_{j = 0}^{J - 1} {\sum }_{k = 0}^{K - 1} ( S1\_ [ j , k ] \times t\_ [ j , k ] - S2\_ [ j , k ] \times t\_ [ j , k ] ) & Formula 1\end{matrix}$$

Furthermore, each of the pixels outputs the reset level and the signal level in a predetermined order in a case where the sign of the corresponding filter coefficient is positive, and outputs the reset level and the signal level in a reverse order in a case where the sign is negative. For example, in a case where the filter coefficient is positive, the pixel outputs the signal level and the reset level in this order, and in a case where the filter coefficient is negative, the pixel outputs the reset level and the signal level in this order. As described above, by changing the output order according to the sign of the filter coefficient, the sign of the filter coefficient can be reflected on the sign of the difference after the CDS processing.

Furthermore, the image recognition section 290 includes a convolutional neural network (CNN) processing section 291 and a data collation section 292. The CNN processing section 291 performs CNN processing on the digital signal of each of the ADCs. The CNN includes a plurality of convolution layers, and the product-sum operation of the first convolution layer among them is realized by an analog circuit including the plurality of integration circuits and a comparator (not illustrated) in the ADC. The operation of the second and subsequent convolution layers is executed by the CNN processing section 291. The CNN processing section 291 supplies data of processed feature amount to the data collation section 292.

The data collation section 292 collates the feature amount obtained by the CNN processing with a feature amount of a recognition target. The data collation section 292 outputs a collation result as a recognition result.

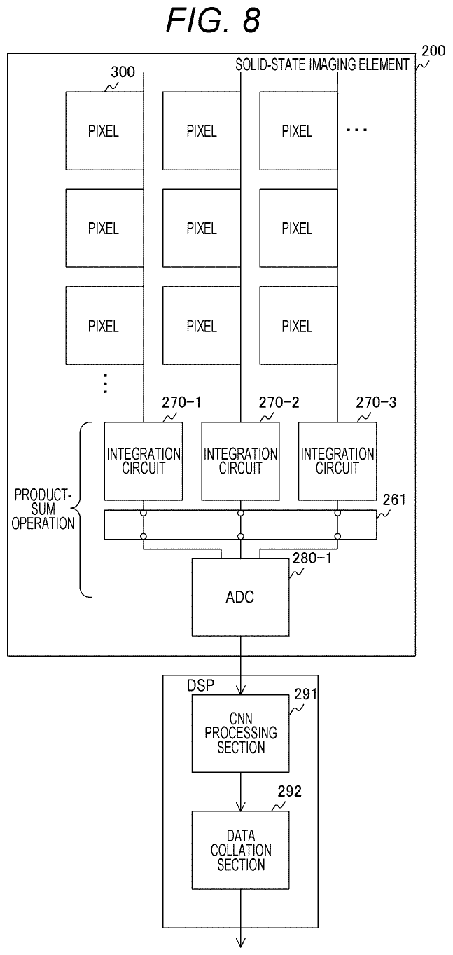

Note that, although the CNN processing section 291 and the data collation section 292 are disposed in the solid-state imaging element 200, all or a part of them may be disposed outside the solid-state imaging element 200. For example, as illustrated in FIG. 8, the CNN processing section 291 and the data collation section 292 can be disposed in a digital signal processing (DSP) circuit outside the solid-state imaging element 200.

Furthermore, although the ADC performs both the AD conversion processing and the CDS processing by the up count and the down count, only the AD conversion processing can be performed by one of the up count and the down count. In this case, a subsequent circuit executes the CDS processing.

Here, a configuration in which the product-sum operation of the convolution layer is performed after AD conversion is assumed as a comparative example.

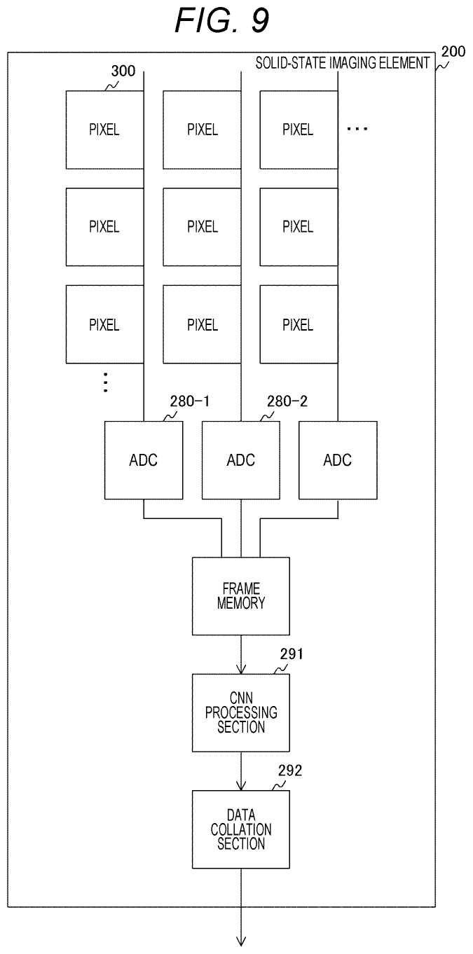

FIG. 9 is an example of an overall view of a solid-state imaging element 200 in a comparative example. In the comparative example, an ADC is disposed for each column. Furthermore, the integration circuit 270-1 and the like and the switching circuit 261 are not disposed, and a frame memory is further disposed. The frame memory holds image data including a digital signal after AD conversion. A CNN processing section 291 performs CNN processing on the image data in the frame memory. The product-sum operation of the first convolution layer of the CNN is performed by a digital circuit.

On the other hand, in the solid-state imaging element 200 illustrated in FIGS. 7 and 8, since it is not necessary to hold the image data in the frame memory, power consumption can be reduced as compared with the comparative example. Furthermore, in the solid-state imaging element 200 illustrated in FIGS. 7 and 8, since the product-sum operation of the first convolution layer is performed by the integration circuit for each column and the ADC for each three columns in parallel, the processing speed can be faster than in the comparative example. Furthermore, since the integration signals of the three columns are simultaneously added, the processing speed can be faster than that in Non-Patent Document 1 in which the integration signals of the three columns are added one by one. As a result, in particular, the accuracy of image recognition for a moving subject can be improved.

Moreover, since the filter coefficient is reflected in the integration time, any filter coefficient can be set, and the accuracy of image recognition can be improved as compared with Non-Patent Document 1 in which the filter coefficients are limited to +1, 0, and −1.

Furthermore, in the solid-state imaging element 200 in FIGS. 7 and 8, since exposure is performed by the global shutter method, rolling shutter distortion is eliminated, and surface simultaneity can be maintained. As a result, it is possible to perform image recognition using high-quality image data equivalent to that of a normal CMOS image sensor (CIS). Since such a solid-state imaging element 200 is advantageous for recognition of a moving object moving at a high speed, it can be used for the following various applications.
(1) Application in which the solid-state imaging element 200 is mounted on a vehicle-mounted camera and automated driving is realized using a result of image recognition processing.
(2) Application in which the solid-state imaging element 200 is mounted on an industrial camera and various inspections are performed using a result of image recognition processing.
(3) Application in which the solid-state imaging element 200 is mounted on a smart device installed in a traffic signal or the like in a city, and traffic regulation or the like is performed using a result of image recognition processing.
(4) Application in which the solid-state image element 200 is mounted on a monitoring camera in a store, and shoplifting is detected or a purchase trend of a customer is analyzed using a result of image recognition processing.
(5) Application in which the solid-state imaging element 200 is mounted on a camera provided in a stadium or the like, and data analysis regarding sports is performed using a result of image recognition processing.

### [Operation Example of Solid-State Imaging Element]

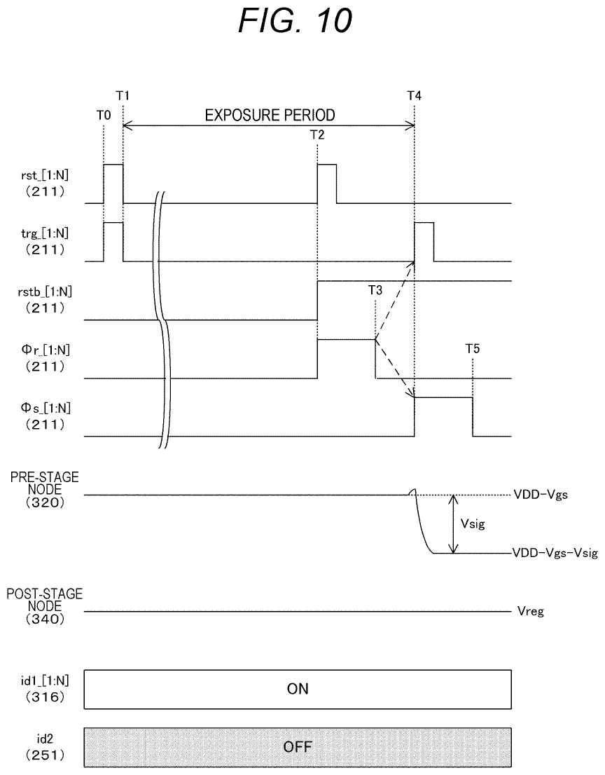

FIG. 10 is a timing chart illustrating an example of a global shutter operation according to the first embodiment of the present technology. The vertical scanning circuit 211 supplies the high-level FD reset signal rst and the high-level transfer signal trg to all the rows (in other words, all the pixels) over a period from timing TO immediately before the start of exposure to timing T1 after the pulse period has elapsed. Therefore, all the pixels are PD reset, and the exposure simultaneously starts in all the rows.

Here, rst_[n] and trg_[n] in the drawing indicate signals to pixels in an n-th row among N rows. N is an integer indicating the total number of rows, and n is an integer from 1 to N.

Then, at timing T2 immediately before the end of the exposure period, the vertical scanning circuit 211 supplies the high-level FD reset signal rst over the pulse period while setting the post-stage reset signal rstb and the selection signal or to the high level for all the pixels. Therefore, all the pixels are FD reset, and the reset level is sampled and held. Here, rstb_[n] and Φr_[n] in the drawing indicate signals to pixels in the n-th row.

At timing T3 after timing T2, the vertical scanning circuit 211 returns the selection signal or to the low level.

At timing T4 that is the end of exposure, the vertical scanning circuit 211 supplies the high-level transfer signal trg over the pulse period while setting the post-stage reset signal rstb and the selection signal os to the high level for all the pixels. As a result, the signal level is sampled and held. Furthermore, the level of the pre-stage node 320 decreases from the reset level (VDD−Vgs) to the signal level (VDD−Vgs−Vsig). Here, VDD indicates a power supply voltage, and Vsig indicates a net signal level obtained as a result of the CDS processing. Vgs indicates a gate-source voltage of the pre-stage amplification transistor 315. Furthermore, Φs_[n] in the drawing indicates signals to pixels in the n-th row.

At timing T5 after timing T4, the vertical scanning circuit 211 returns the selection signal Φs to the low level.

Furthermore, the vertical scanning circuit 211 controls the current source transistors 316 of all the rows (all the pixels) to supply the current id1. Here, id1_[n] in the drawing indicates a current of pixels in the n-th row. The larger the current id, the larger IR drop becomes, so that it is required that the current id1 is to be on the order of several nanoamperes (nA) to several tens of nanoamperes (nA). On the other hand, the load MOS transistors 251 of all the columns are in an off state, and the current id2 is not supplied to the vertical signal line 309.

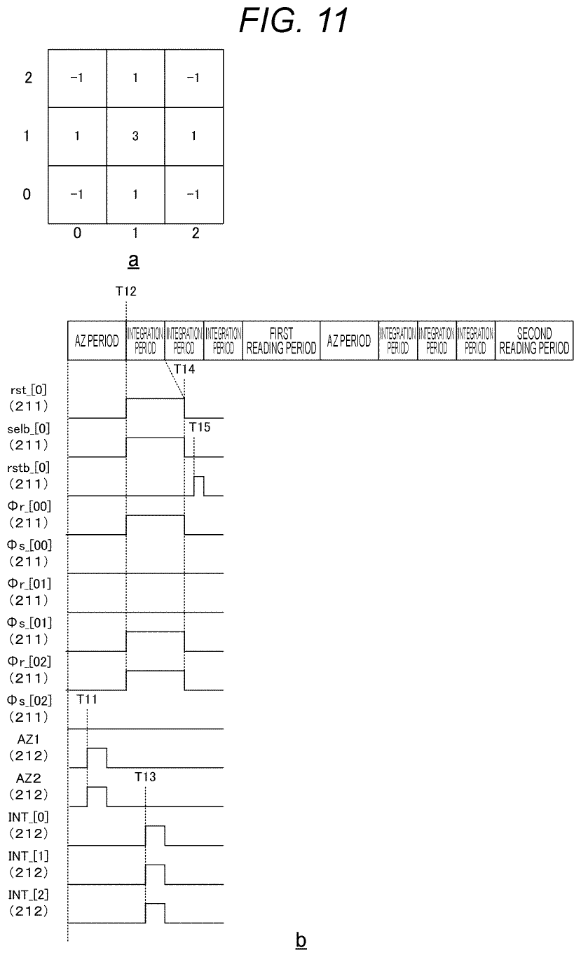

FIG. 11 is a timing chart illustrating an example of the first auto-zero operation and the first (in other words, the zeroth row) integration operation according to the first embodiment of the present technology. a in the drawing illustrates an example of a filter. The size of the filter is 3 rows×3 columns, and relative rows and columns in the filter are set to zeroth, first, and second rows and zeroth, first, and second columns.

After exposure by the global shutter method, the solid-state imaging element 200 performs convolution integration while sliding the filter in the horizontal direction or the vertical direction. However, as described above, since the ADCs are disposed every three columns, the solid-state imaging element 200 can execute M/3 convolution integrations in parallel, where the number of columns is M. Therefore, the number of times of sliding in the horizontal direction is two.

Furthermore, the operation period of the convolutional integration for three rows includes a first auto-zero period, an integration period for three rows, a first reading period, a second auto-zero period, an integration period for three rows, and a second reading period.

b in the drawing is a timing chart illustrating an example of the first auto-zero operation and the first (zeroth row) integration operation.

In the first auto-zero period, the vertical scanning circuit 211 supplies the high-level control signals AZ1 and AZ2 from timing T11 to the pulse period.

The vertical scanning circuit 211 supplies the high-level FD reset signal rst and the post-stage selection signal selb to the zeroth row during the integration period of the zeroth row from timing T12 to T14. In the drawing, selb_[n] indicates signals to pixels of the nth row.

At timing T15 immediately after the integration time of the zeroth row, the vertical scanning circuit 211 supplies the high-level post-stage reset signal rstb to the zeroth row.

Furthermore, the vertical scanning circuit 211 sets one of the selection signals Φr and Φs to the high level and outputs one of the reset level and the signal level for each column within the integration period of the zeroth row. Which of the selection signals Φr and Φs is set to the high level is determined by the sign of the corresponding filter coefficient.

For example, it is assumed that filter coefficients in the zeroth row, the zeroth, first, and second columns are “−1”, “+1”, and “−1”. In this case, the selection signal Φr_[00] or in the zeroth row and the zeroth column is controlled to the high level, the selection signal Φs_[01] in the zeroth row and the first column is controlled to the high level, and the selection signal Φr_[02] in the zeroth row and the second column is controlled to the high level. As a result, the reset level is output from the zeroth row and the zeroth column, the signal level is output from the zeroth row and the first column, and the reset level is output from the zeroth row and the second column.

Furthermore, after timing T13 within the integration period of the zeroth row, the timing control circuit 212 supplies a control signal INT for time-integrating the pixel signals to each column. INT_[m] in the drawing indicates a signal to the integration circuit of the mth (m is 0, 1, or 2) column. A pulse width of the control signal INT_[m] is a value corresponding to the absolute value of the corresponding filter coefficient. Since the filter coefficients in the zeroth row and the zeroth, first, and second columns are “−1”, “+1”, and “−1”, and their absolute values are the same, the pulse widths of the control signals INT_[0], INT_[1], and INT_[2] are set to be the same.

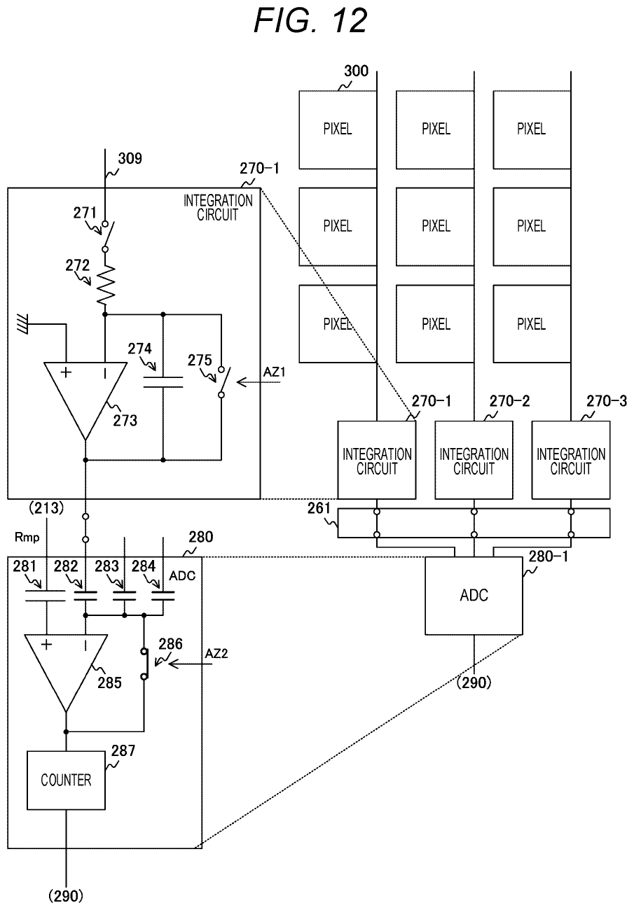

FIG. 12 is a diagram illustrating an example of a state of the solid-state imaging element 200 within the first auto-zero period according to the first embodiment of the present technology. In the integration circuit of each column, the auto-zero switch 275 is closed by the control signal AZ1, and the integration circuit is reset. Furthermore, in each ADC, the auto-zero switch 286 is closed by the control signal AZ2, and the comparator 285 is reset.

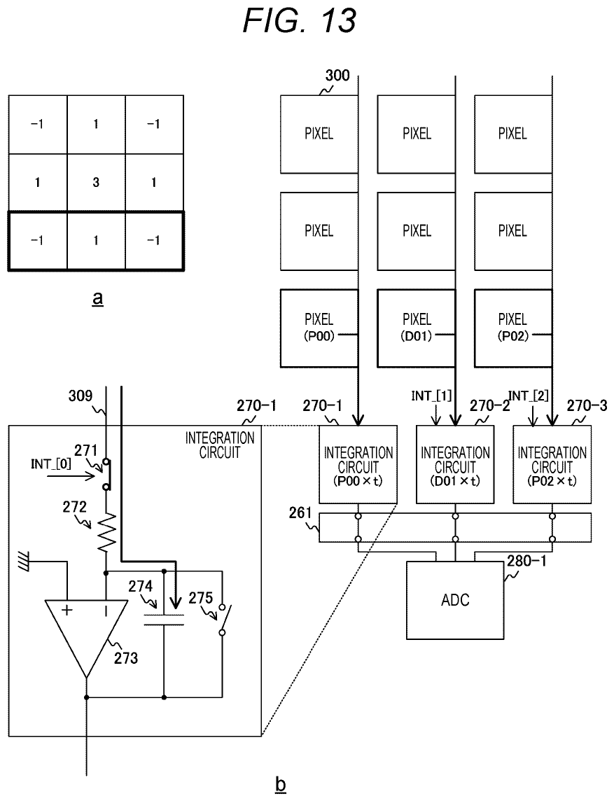

FIG. 13 is a diagram illustrating an example of a state of the solid-state imaging element 200 within the first integration period (in the zeroth row) according to the first embodiment of the present technology. A portion surrounded by a thick frame in a of the drawing indicates a position of the pixel to be integrated.

b in the drawing illustrates an example of a state of the solid-state imaging element 200 within the first integration period (in the zeroth row). In the integration circuit of each column, the input switch 271 is closed over the integration time according to the absolute value of the filter coefficient by the control signal INT. The filter coefficients “−1”, “+1”, and “−1” in the zeroth row and the zeroth, first, and second columns have the same absolute value, and thus the integration times of the respective columns are the same.

The integration time of each column is t, and the reset level (P-phase level) output from the pixel in the zeroth row and the zeroth column is POO. The signal level (D-phase level) output from the pixel in the zeroth row and the first column is D01, and the reset level (P-phase level) output from the pixel in the zeroth row and the second column is P02. In this case, the integration signals of the zeroth, first, and second columns are P00×t, D01×t, and P02×t.

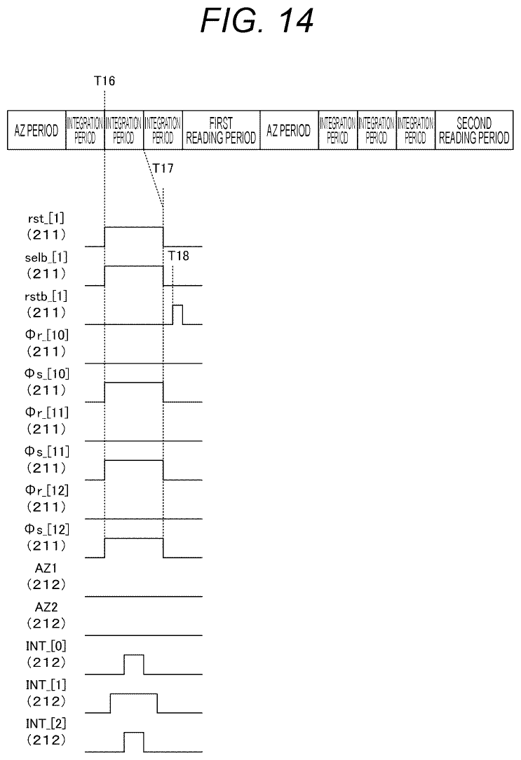

FIG. 14 is a timing chart illustrating an example of the second (in other words, the first row) integration operation according to the first embodiment of the present technology.

During the integration period of the first row from timing T16 to T17, the vertical scanning circuit 211 supplies the high-level FD reset signal rst and the post-stage selection signal selb to the first row.

At timing T18 immediately after the integration time of the first row, the vertical scanning circuit 211 supplies the high-level post-stage reset signal rstb to the first row.

Furthermore, it is assumed that filter coefficients in the first row and the zeroth, first, and second columns are “+1”, “+3”, and “+1”. In this case, during the integration period of the first row, the selection signal Φs_[10] of the first row and the zeroth column is controlled to the high level, the selection signal Φs_[11] of the first row and the first column is controlled to the high level, and the selection signal Φs_[12] of the first row and the second column is controlled to the high level. As a result, the signal level is output from each of the zeroth column, the first column, and the second column of the first row.

Furthermore, within the integration period of the first row, the timing control circuit 212 supplies a control signal INT for time-integrating the pixel signals to each column. Since the filter coefficients in the zeroth row and the zeroth, first, and second columns are “+1”, “+3”, and “+1”, the pulse width of the control signal INT_[1] is set to three times the pulse widths of the control signal INT_[0] and the control signal INT_[2].

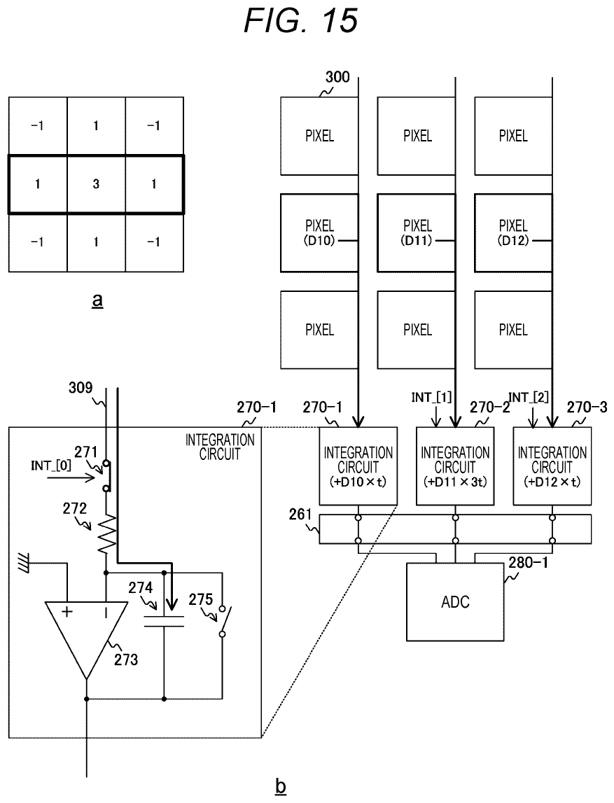

FIG. 15 is a diagram illustrating an example of a state of the solid-state imaging element 200 within the second integration period (in the first row) according to the first embodiment of the present technology. A portion surrounded by a thick frame in a of the drawing indicates a position of the pixel to be integrated.

b in the drawing illustrates an example of a state of the solid-state imaging element 200 within the second integration period. In the integration circuit of each column, the input switch 271 is closed over the integration time according to the absolute value of the filter coefficient by the control signal INT. Since the filter coefficients in the first row and the zeroth, first, and second columns are “+1”, “+3”, and “+1”, the integration time of the first column is three times the integration time of the zeroth and second columns.

The integration time of the zeroth column is t, and the signal level (D-phase level) output from the pixel in the first row and the zeroth column is D10. A signal level (D-phase level) output from the pixel in the first row and the first column is D11, and a signal level (D-phase level) output from the pixel in the first row and the second column is D12. In this case, the integration signal of the zeroth column is P00×t+D10×t, the integration signal of the first column is D01×t+D11×3t, and the integration signal of the second column is P02×t+D12×t.

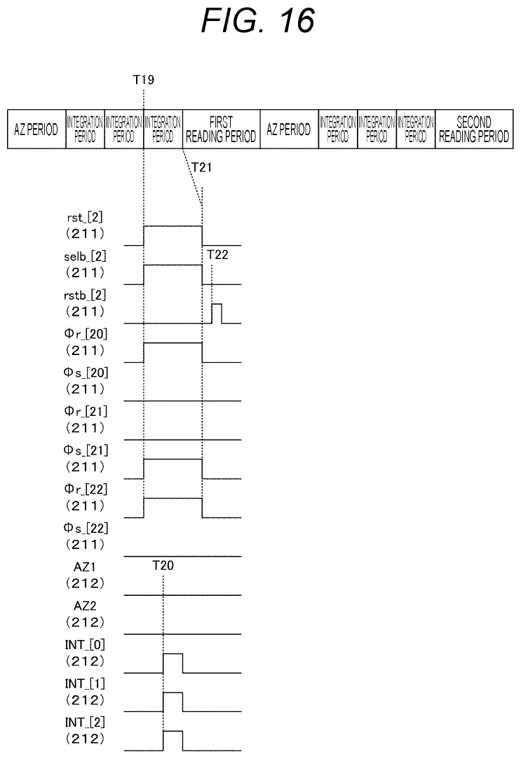

FIG. 16 is a timing chart illustrating an example of the third (in other words, the second row) integration operation according to the first embodiment of the present technology.

During the integration period of the second row from timing T19 to T21, the vertical scanning circuit 211 supplies the high-level FD reset signal rst and the post-stage selection signal selb to the second row.

At timing T22 immediately after the integration time of the second row, the vertical scanning circuit 211 supplies the high-level post-stage reset signal rstb to the second row.

Furthermore, it is assumed that filter coefficients in the second row and the zeroth, first, and second columns are “−1”, “+1”, and “−1”. In this case, the selection signal Φr_[20] in the second row and the zeroth column is controlled to the high level, the selection signal Φs_[21] in the second row and the first column is controlled to the high level, and the selection signal Φr_[22] or in the second row and the second column is controlled to the high level. As a result, the reset level is output from the second row and the zeroth column, the signal level is output from the second row and the first column, and the reset level is output from the second row and the second column.

Furthermore, after timing T20 within the integration period of the second row, the timing control circuit 212 supplies a control signal INT for time-integrating the pixel signals to each column. Since the filter coefficients in the second row and the zeroth, first, and second columns are “−1”, “+1”, and “−1”, and their absolute values are the same, the pulse widths of the control signals INT_[0], INT_[1], and INT_[2] are set to be the same.

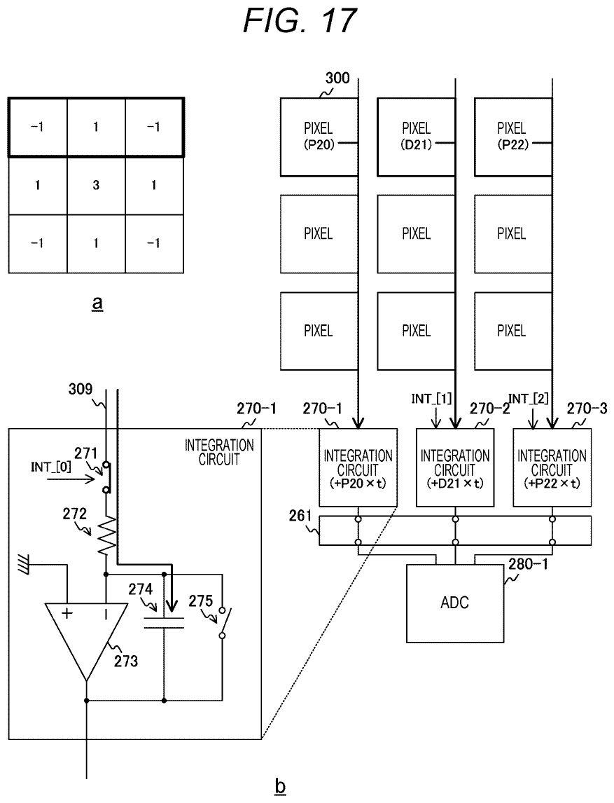

FIG. 17 is a diagram illustrating an example of a state of the solid-state imaging element within the third integration period (in the second row) according to the first embodiment of the present technology. A portion surrounded by a thick frame in a of the drawing indicates a position of the pixel to be integrated.

b in the drawing illustrates an example of a state of the solid-state imaging element 200 within the third integration period (in the second row). In the integration circuit of each column, the input switch 271 is closed over the integration time according to the absolute value of the filter coefficient by the control signal INT. The filter coefficients “−1”, “+1”, and “−1” in the first row and the zeroth, first, and second columns have the same absolute value, and thus the integration times of the respective columns are the same.

The integration time of each column is t, and the reset level (P-phase level) output from the pixel in the second row and the zeroth column is P20. The signal level (D-phase level) output from the pixel in the second row and the first column is denoted by D21, and the reset level (P-phase level) output from the pixel in the second row and the second column is denoted by P22. In this case, the integration signal of the zeroth column is P00×t+D10×t+P20×t. Furthermore, the integration signal of the first column is D01×t+D11×3t+D21×t, and the integration signal of the second column is P02×t+D12×t+P22× t.

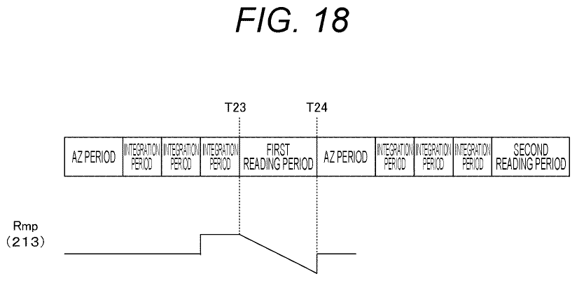

FIG. 18 is a timing chart illustrating an example of the first reading operation according to the first embodiment of the present technology. The ramp signal Rmp gradually fluctuates within the reading period from timing T23 to T24, and AD conversion is performed.

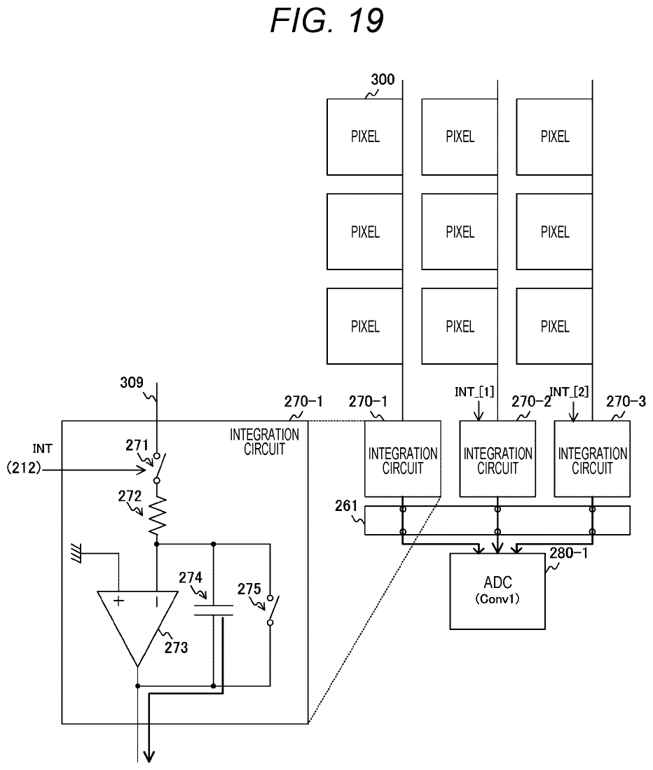

FIG. 19 is a diagram illustrating an example of a state of the solid-state imaging element 200 within the first reading period according to the first embodiment of the present technology. The integration circuits 270-1, 270-2, and 270-3 supply the held integration signal to the ADC 280-1. The ADC 280-1 AD-converts a signal obtained by analog-adding this integration signal into a digital signal Conv1. The digital signal Conv1 is expressed by the following formula.

$$Conv 1 = P 00 \times t + D 10 \times t + P 20 \times t + D 01 \times t + D 11 \times 3 t + D 21 \times t + P 02 \times t + D 12 \times t + P 22 \times t \qquad Formula 2$$

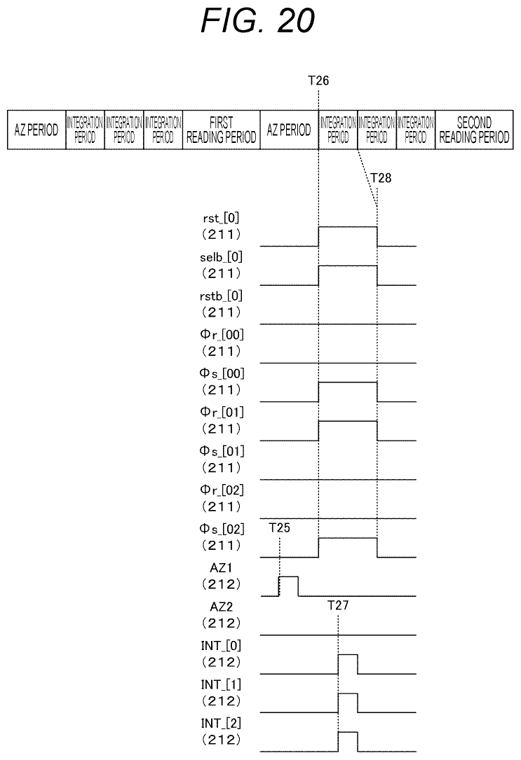

FIG. 20 is a timing chart illustrating an example of the second auto-zero operation and the fourth (in other words, the zeroth row) integration operation according to the first embodiment of the present technology.

In the second auto-zero period, the vertical scanning circuit 211 supplies the high-level control signal AZ1 to the nth row from timing T25 over the pulse period.

The vertical scanning circuit 211 supplies the high-level FD reset signal rst and the post-stage selection signal selb to the zeroth row during the integration period of the zeroth row from timing T26 to T28.

Furthermore, it is assumed that filter coefficients in the zeroth row and the zeroth, first, and second columns are “−1”, “+1”, and “−1”. In this case, the selection signal Φs_[00] of the zeroth row and the zeroth column is controlled to the high level, the selection signal Φr_[01] of the zeroth row and the first column is controlled to the high level, and the selection signal Φs_[02] of the zeroth row and the second column is controlled to the high level. As a result, the signal level is output from the zeroth row and the zeroth column, the reset level is output from the zeroth row and the first column, and the signal level is output from the zeroth row and the second column.

Furthermore, after timing T27 within the integration period of the zeroth row, the timing control circuit 212 supplies a control signal INT for time-integrating the pixel signals to each column. Since the absolute values of the filter coefficients in the zeroth row and the zeroth, first, and second columns are the same, the pulse widths of the control signals INT_[0], INT_[1], and INT [2] are set to be the same.

As illustrated in b of FIG. 11 and FIG. 20, for each of the pixels, the vertical scanning circuit 211 sets one of the selection signals Φr and Φs to the high level within the first integration period, and sets the other of Φr and Φs to the high level within the second integration period after a certain period. By this control, the selection circuit 330 of the selected row sequentially performs control to connect the capacitive element 321 to the post-stage node 340, control to disconnect the capacitive elements 321 and 322 from the post-stage node 340, and control to connect the capacitive element 322 to the post-stage node 340. Furthermore, when the capacitive elements 321 and 322 are disconnected from the post-stage node 340, the post-stage reset transistor 341 of the selected row initializes the level of the post-stage node 340. In this manner, by disconnecting the capacitive elements 321 and 322 at the time of driving the post-stage reset transistor 341, kTC noise can be reduced.

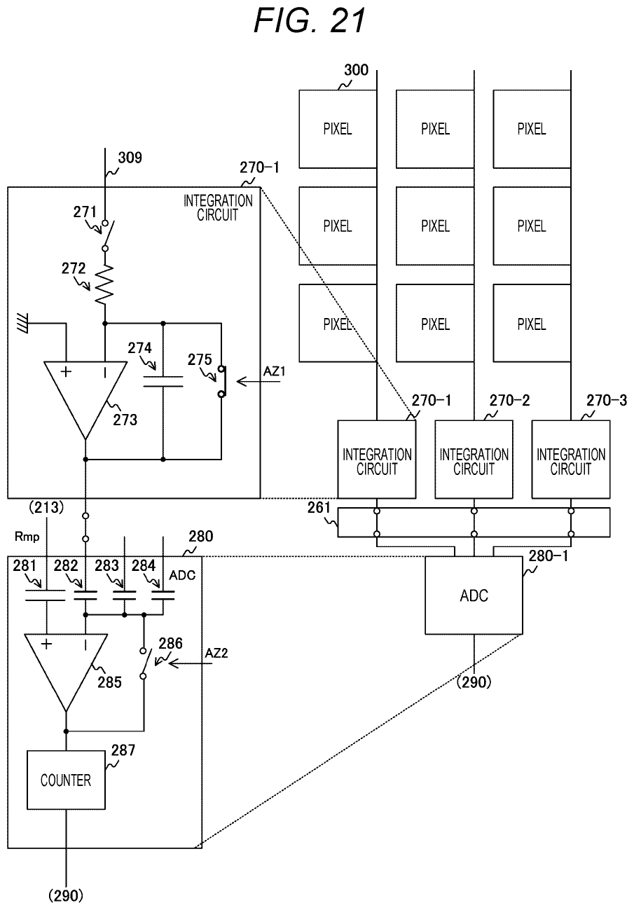

FIG. 21 is a diagram illustrating an example of a state of the solid-state imaging element within the second auto-zero period according to the first embodiment of the present technology. In the integration circuit of each column, the auto-zero switch 275 is closed by the control signal AZ1, and the integration circuit is reset.

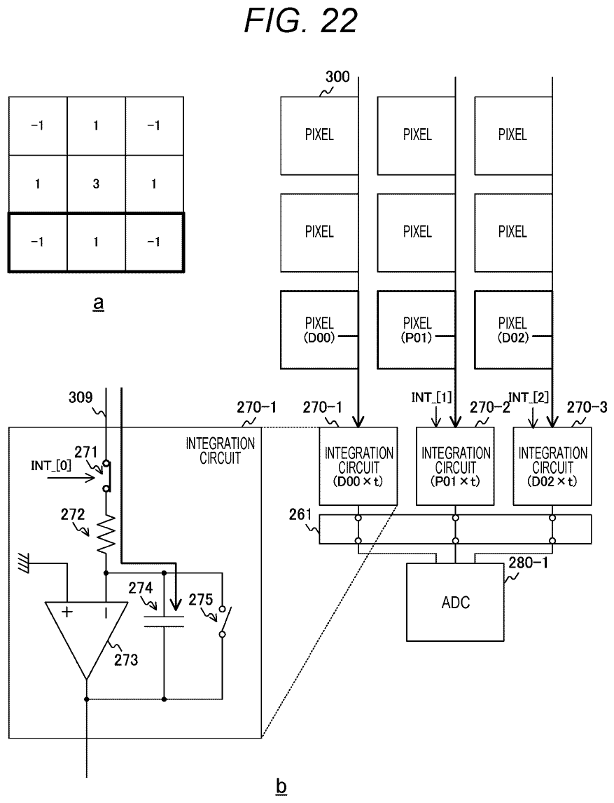

FIG. 22 is a diagram illustrating an example of a state of the solid-state imaging element within the fourth integration period (in the zeroth row) according to the first embodiment of the present technology. A portion surrounded by a thick frame in a of the drawing indicates a position of the pixel to be integrated.

b in the drawing illustrates an example of a state of the solid-state imaging element 200 within the fourth integration period (in the zeroth row). In the integration circuit of each column, the input switch 271 is closed over the integration time according to the absolute value of the filter coefficient by the control signal INT. The filter coefficients “−1”, “+1”, and “−1” in the zeroth row and the zeroth, first, and second columns have the same absolute value, and thus the integration times of the respective columns are the same.

The integration time of each column is t, and the signal level (D-phase level) output from the pixel in the zeroth row and the zeroth column is D00. The reset level (P-phase level) output from the pixel in the zeroth row and the first column is P01, and the signal level (D-phase level) output from the pixel in the zeroth row and the second column is D02. In this case, the integration signals of the zeroth, first, and second columns are D00×t, P01×t, and D02×t.

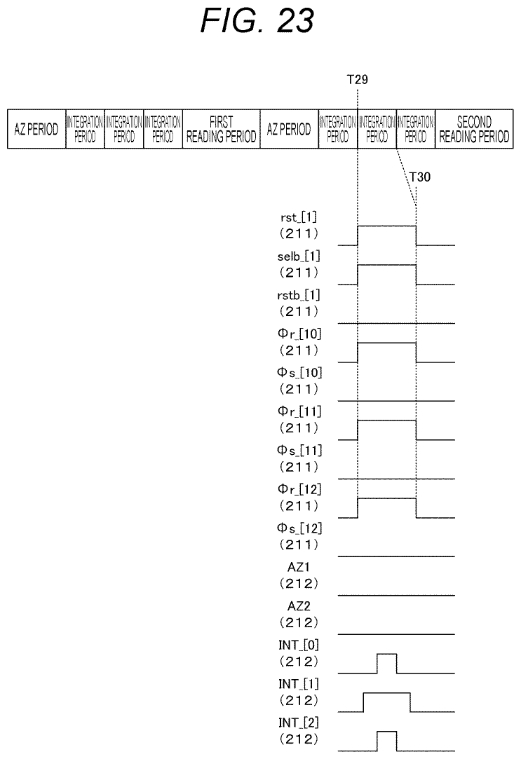

FIG. 23 is a timing chart illustrating an example of the fifth (in other words, the first row) integration operation according to the first embodiment of the present technology.

During the integration period of the first row from timing T29 to T30, the vertical scanning circuit 211 supplies the high-level FD reset signal rst and the post-stage selection signal selb to the first row.

Furthermore, the filter coefficients in the first row and the zeroth, first, and the second columns are “+1”, “+3”, and “+1”. In this case, during the integration period of the first row, the selection signal Φr_[10] of the first row and the zeroth column is controlled to the high level, the selection signal Φr_[11] or of the first row and the first column is controlled to the high level, and the selection signal Φr_[12] of the first row and the second column is controlled to the high level. As a result, the reset level is output from each of the zeroth column, the first column, and the second column of the first row.

Furthermore, within the integration period of the first row, the timing control circuit 212 supplies a control signal INT for time-integrating the pixel signals to each column. Since the filter coefficients in the zeroth row and the zeroth, first, and second columns are “+1”, “+3”, and “+1”, the pulse width of the control signal INT_[1] is set to three times the pulse widths of the control signal INT_[0] and the control signal INT_[2].

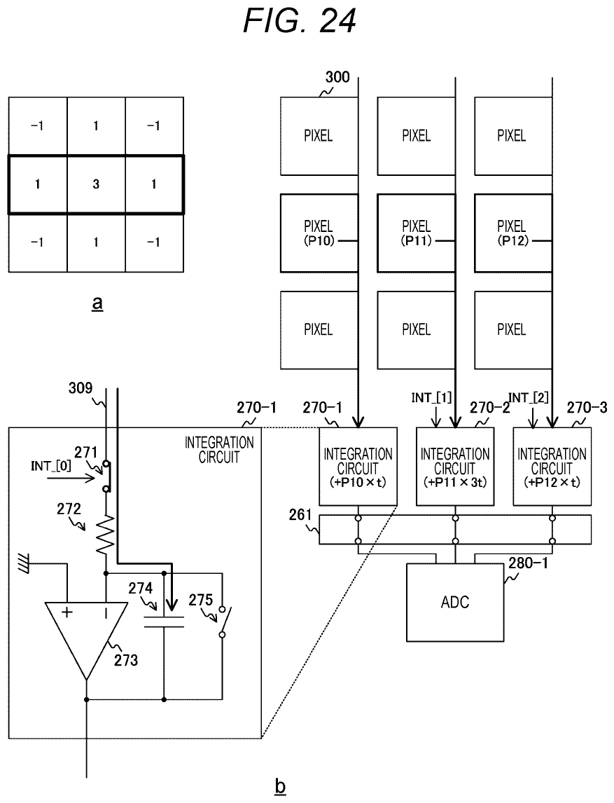

FIG. 24 is a diagram illustrating an example of a state of the solid-state imaging element within the fifth integration period (in the first row) according to the first embodiment of the present technology. A portion surrounded by a thick frame in a of the drawing indicates a position of the pixel to be integrated.

b in the drawing illustrates an example of a state of the solid-state imaging element 200 within the fifth integration period. In the integration circuit of each column, the input switch 271 is closed over the integration time according to the absolute value of the filter coefficient by the control signal INT. Since the filter coefficients in the first row and the zeroth, first, and second columns are “+1”, “+3”, and “+1”, the integration time of the first column is three times the integration time of the zeroth and second columns.

The integration time of the zeroth column is t, and the reset level (P-phase level) output from the pixel of the first row and the zeroth column is P10. The reset level (P-phase level) output from the pixel in the first row and the first column is P11, and the reset level (P-phase level) output from the pixel in the first row and the second column is P12. In this case, the integration signal of the zeroth column is D00×t+P10×t, the integration signal of the first column is P01×t+P11×3t, and the integration signal of the second column is D02×t+P12×t.

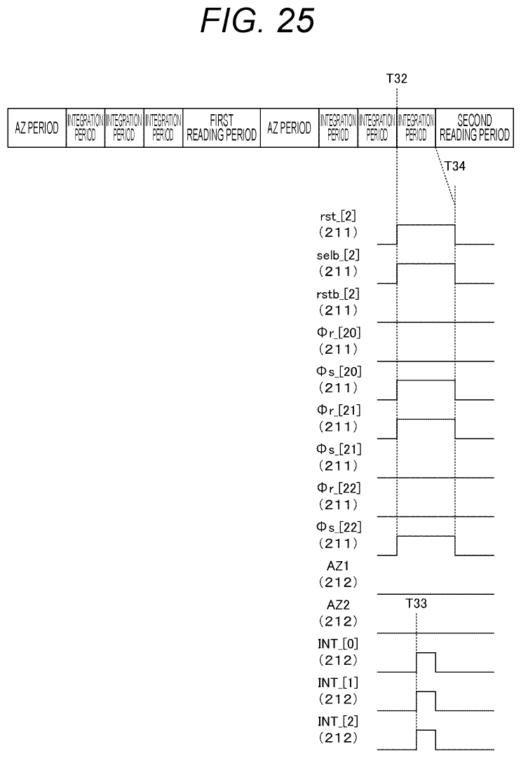

FIG. 25 is a timing chart illustrating an example of sixth (in other words, the second row) integration operation according to the first embodiment of the present technology.

During the integration period of the second row from timing T32 to T34, the vertical scanning circuit 211 supplies the high-level FD reset signal rst and the post-stage selection signal selb to the second row.

Furthermore, it is assumed that filter coefficients in the second row and the zeroth, first, and second columns are “−1”, “+1”, and “−1”. In this case, the selection signal Φs_[20] in the second row and the zeroth column is controlled to the high level, the selection signal Φr_[21] or in the second row and the first column is controlled to the high level, and the selection signal Φs_[22] in the second row and the second column is controlled to the high level. As a result, the signal level is output from the second row and the zeroth column, the reset level is output from the second row and the first column, and the signal level is output from the second row and the second column.

Furthermore, after timing T33 within the integration period of the second row, the timing control circuit 212 supplies a control signal INT for time-integrating the pixel signals to each column. Since the filter coefficients in the second row and the zeroth, first, and second columns are “−1”, “+1”, and “−1”, and their absolute values are the same, the pulse widths of the control signals INT_[0], INT_[1], and INT_[2] are set to be the same.

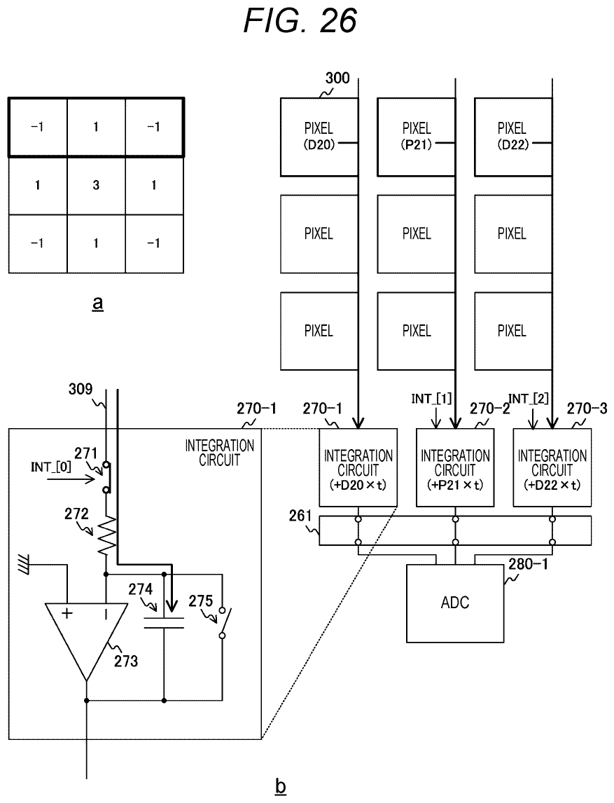

FIG. 26 is a diagram illustrating an example of a state of the solid-state imaging element within the sixth integration period (in the second row) according to the first embodiment of the present technology. A portion surrounded by a thick frame in a of the drawing indicates a position of the pixel to be integrated.

b in the drawing illustrates an example of a state of the solid-state imaging element 200 within the sixth integration period. In the integration circuit of each column, the input switch 271 is closed over the integration time according to the absolute value of the filter coefficient by the control signal INT. The filter coefficients “−1”, “+1”, and “−1” in the first row and the zeroth, first, and second columns have the same absolute value, and thus the integration times of the respective columns are the same.

The integration time of each column is t, and the signal level (D-phase level) output from the pixel of the second row and the zeroth column is D20. The reset level (P-phase level) output from the pixel in the second row and the first column is P21, and the signal level (D-phase level) output from the pixel in the second row and the second column is D22. In this case, the integration signal of the zeroth column is D00×t+P10×t+D20×t. Furthermore, the integration signal of the first column is P01×t+P11×3t+P21×t, and the integration signal of the second column is D02×t+P12×t+D22×t.

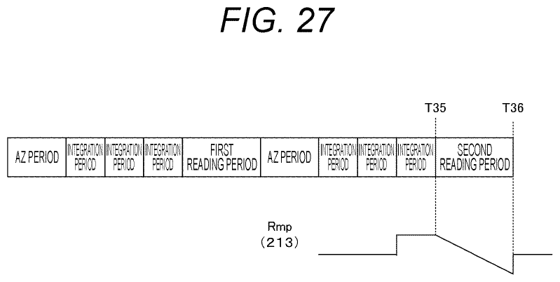

FIG. 27 is a timing chart illustrating an example of the second reading operation according to the first embodiment of the present technology. The ramp signal Rmp gradually fluctuates within the reading period from timing T35 to T36, and AD conversion is performed.

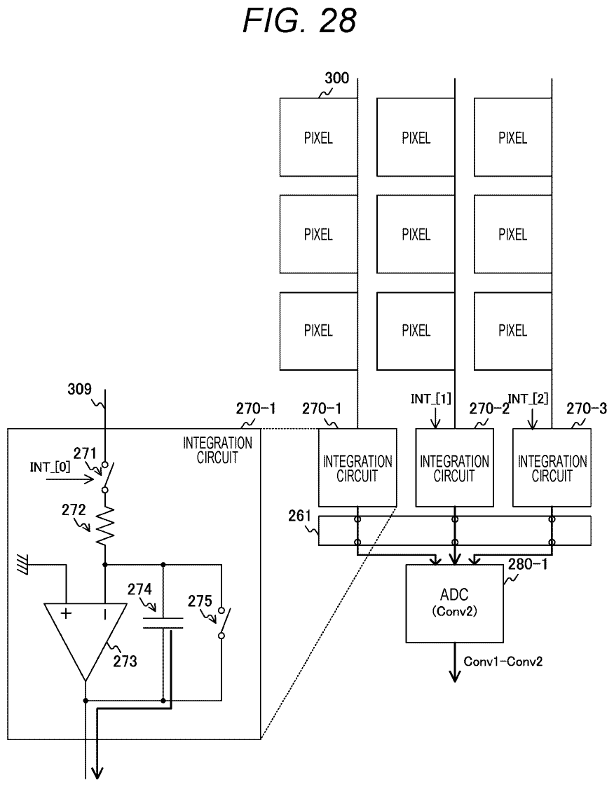

FIG. 28 is a diagram illustrating an example of a state of the solid-state imaging element 200 within the second reading period according to the first embodiment of the present technology. The integration circuits 270-1, 270-2, and 270-3 supply the held integration signal to the ADC 280-1. The ADC 280-1 AD-converts the signal obtained by analog-adding this integration signal into the digital signal Conv2, and calculates Convd that is a difference between the first digital signal Conv1 and the second digital signal Conv2. These are expressed by the following formula.

$$Conv 2 = D 00 \times t + P 10 \times t + D 20 \times t + P 01 \times t + P 11 \times 3 t + P 21 \times t + D 02 \times t + P 12 \times t + D 22 \times t \qquad Formula 3$$

$$Convd = Conv 1 - Conv 2 \qquad Formula 4$$

Formula 4 is equivalent to Formula 1 when both J and K are “3”.

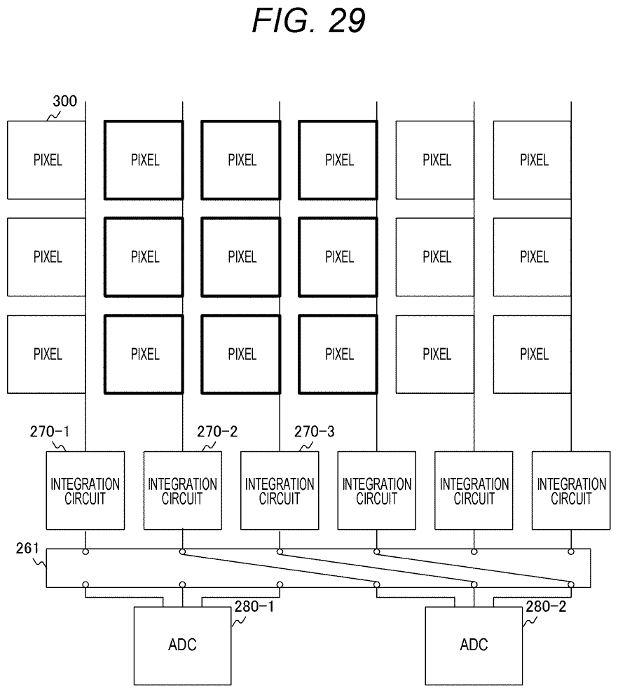

FIG. 29 is a diagram illustrating an example of a state of the solid-state imaging element 200 when the filter according to the first embodiment of the present technology is slid by one column in the horizontal direction. Pixels in thick frames in the drawing indicate pixels to which the filter is applied. For example, the switching circuit 261 switches the output destinations of the integration circuits 270-2 and 270-3 to the ADC 280-2. In the case of sliding for two columns, the switching circuit 261 switches the output destination of the integration circuits 270-1 and 270-2 to the ADC 280-1, and switches the output destination of 270-3 to the ADC 280-2. In a case where the filter is slid in the vertical direction, the vertical scanning circuit 211 is only required to change the row addresses of the three rows to be driven.

As illustrated in Formulas 1 to 4, by changing the output order of the reset level and the signal level according to the sign of the filter coefficient, the sign of the filter coefficient can be reflected in the sign of the difference for each pixel.

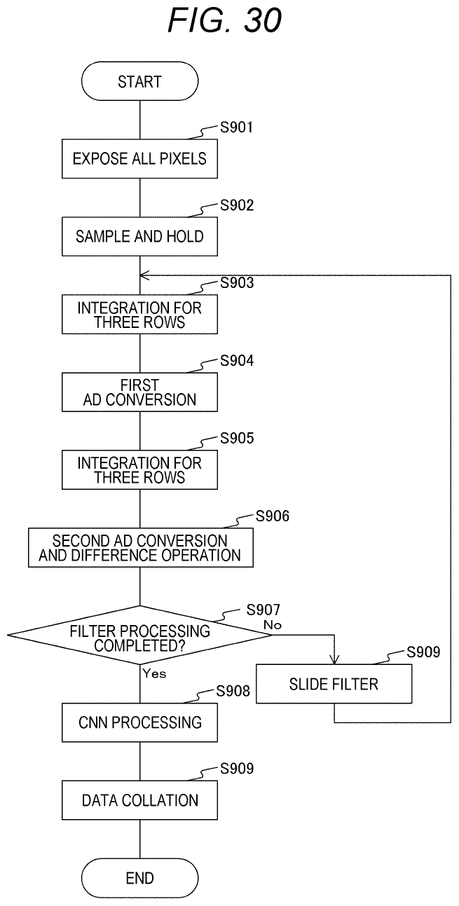

FIG. 30 is a flowchart illustrating an example of the operation of the solid-state imaging element 200 according to the first embodiment of the present technology. This operation is started, for example, when a predetermined application for performing image recognition is executed.

The vertical scanning circuit 211 exposes all the pixels (step S901). Each of the pixels samples and holds the reset level and the signal level (step S902). The vertical scanning circuit 211 selects three rows to be read, and the integration circuit of each column time-integrates the pixel signals (reset level or signal level) for the three rows (step S903). Then, each of the ADCs performs the first AD conversion (step S904). Then, the integration circuit of each column time-integrates the pixel signals for three rows (step S905), and each of the ADCs performs the second AD conversion and difference operation (step S906).

The solid-state imaging element 200 determines whether or not the filter processing has been completed for all the pixels (step S907). In a case where the filter processing is not completed (step S907: No), the solid-state imaging element 200 slides the filter in the horizontal direction or the vertical direction (step S909), and repeatedly executes step S903 and the subsequent steps.

In a case where the filter processing is completed (step S907: Yes), the solid-state imaging element 200 executes CNN processing (step S908) and collates a result of the CNN processing with the data of the feature amount of the recognition target (step S909). After step S909, the solid-state imaging element 200 ends the image recognition processing.

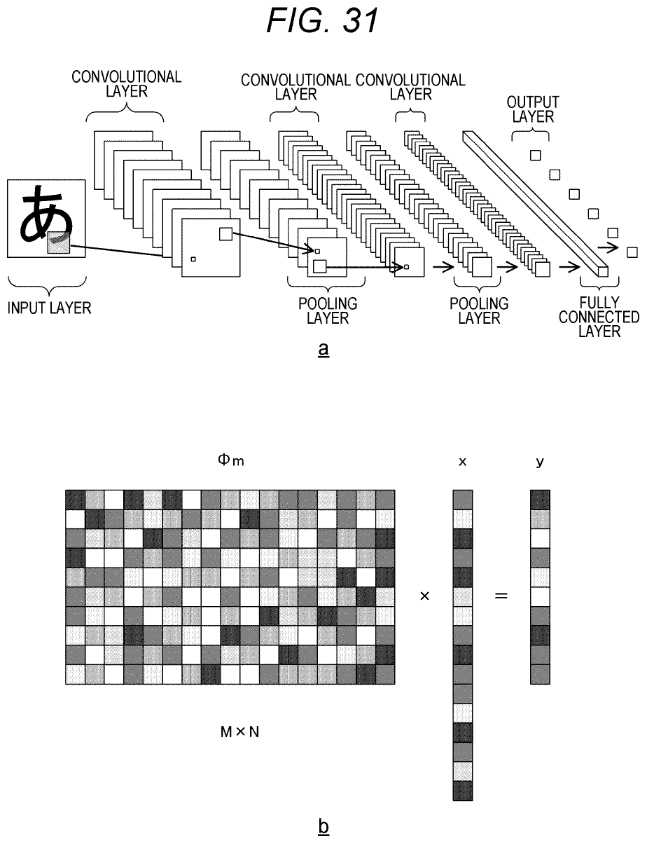

FIG. 31 is a diagram illustrating an example of use of the solid-state imaging element 200 according to the first embodiment of the present technology. In the drawing, a is a diagram illustrating an example of a general CNN. The CNN includes an input layer, multiple stages of convolutional layers, one or more pooling layers, a fully connected layer, and an output layer.

For example, the product-sum operation of the first convolutional layer is executed by the analog circuit including the integration circuits and the ADC illustrated in FIG. 7. Subsequent processing of the layers is executed by the CNN processing section 291 in FIG. 7.

Note that, as illustrated in b of FIG. 31, it can also be used for compression sensing. In the case of use for the compression sensing, the solid-state imaging element 200 calculates observation data y that is a product of a random design matrix Φ and sparse input data x. The pixel signals of all the pixels are used as the input data x. Therefore, the size of the filter is equivalent to the size of image data. In a case where x is sparse, then Φ can be used to recover x from y. The data size of the image data can be reduced by such compression sensing.

As described above, according to the first embodiment of the present technology, since the ADC performs analog addition on the time-integrated signal by the integration circuit and converts the time-integrated signal into a digital signal, the filter coefficient is not limited, and the processing speed is improved. As a result, the accuracy of image recognition can be improved.

### [Modification]

In the first embodiment described above, the solid-state imaging element 200 performs image recognition processing using the integration circuit or the like, but can also capture normal image data without performing convolution integration. The solid-state imaging element 200 according to a modification of the first embodiment is different from that of the second embodiment in that a bypass switch that bypasses an integration circuit is added.

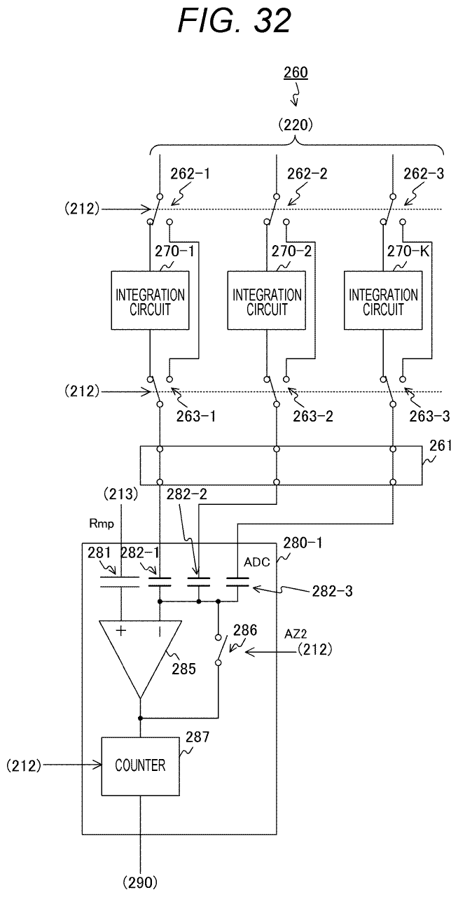

FIG. 32 is a circuit diagram illustrating a configuration example of the column signal processing circuit 260 in the modification of the first embodiment of the present technology. The column signal processing circuit 260 according to the modification of the first embodiment is different from that of the first embodiment in further including bypass switches 262-1 to 262-3 and bypass switches 263-1 to 263-3. Furthermore, in the modification of the second embodiment, the ADCs are disposed for each column.

The bypass switches 262-1 to 262-3 and the bypass switches 263-1 to 263-3 bypass the integration circuits 270-1 to 270-3 under the control of the timing control circuit 212.

For example, either an image recognition mode in which image recognition processing is performed or a normal mode in which image recognition processing is not performed is set in the solid-state imaging element 200. In a case where the normal mode is set, the bypass switches bypass the integration circuits.

Furthermore, in a case where the normal mode is set, the switching circuit 261 connects the bypass switch of each column and the ADC of the column. For example, the bypass switch 263-1 and the ADC 280-1 are connected, and the bypass switch 263-2 and the ADC 280-2 (not illustrated) are connected.

As described above, in the modification of the first embodiment of the present technology, since the bypass switches bypassing the integration circuits are further disposed, it is possible to capture normal image data without performing convolution integration.

### 2. Second Embodiment

In the first embodiment described above, the size of the filter in the horizontal direction is fixed, but the present technology is not limited to this configuration. A solid-state imaging element 200 of the second embodiment is different from that of the first embodiment in that the size of the filter in the horizontal direction is variable.

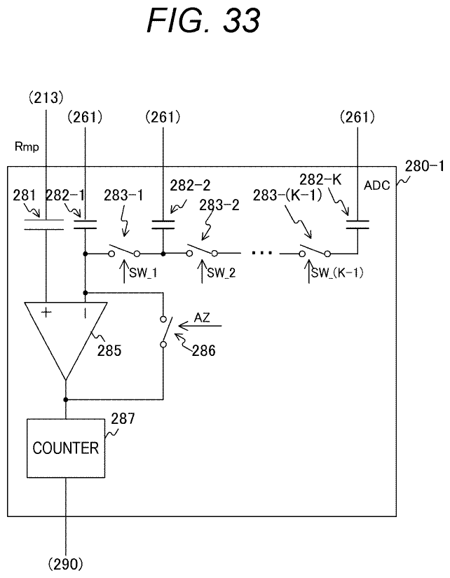

FIG. 33 is a circuit diagram illustrating a configuration example of an ADC 280-1 according to the second embodiment of the present technology. The ADC 280-1 of the second embodiment is different from that of the first embodiment in that it includes connection switches 283-1 to 283-(K−1) where K is the maximum value of the size of the filter in the horizontal direction.

Furthermore, instead of the capacitive elements 282-1 to 282-3, capacitive elements 282-1 to 282-K are provided. One end of each of the capacitive elements 282-1 to 282-K is connected to a corresponding integration circuit via a switching circuit 261, and the other end is commonly connected to an inverting input terminal (−) of a comparator 285.

The connection switch 283-k (k is an integer of 1 to K−1) connects one end of the capacitive element 282-k on the comparator 285 side and one end of the capacitive element 282-(k+1) on the comparator 285 side according to a switching signal SW_k. The switching signal SW_k is supplied from a timing control circuit 212, for example. Among the capacitive elements 282-1 to 282-K, two adjacent capacitive elements are examples of first and second capacitive elements in the claims.

The size of the filter in the horizontal direction can be changed by controlling the number of switches to be closed among the connection switches 283-1 to 283-(K−1).

Furthermore, when the number of columns is M and the minimum size of the filter in the horizontal direction is R (R is an integer), M/R ADCs are disposed. For example, when the minimum size is “2”, the ADCs are disposed every two columns.

Note that the modification of the first embodiment can be applied to the second embodiment.

As described above, according to the second embodiment of the present technology, since the connection switch 283-k that connects one ends of the two adjacent capacitive elements is provided, the size of the filter in the horizontal direction can be made variable.

### 3. Third Embodiment

In the first embodiment described above, the photoelectric conversion element 311 generates and accumulates charges, but image quality in a dark place may be insufficient. A solid-state imaging element 200 in the third embodiment is different from that in the first embodiment in that an embedded photodiode is used as the photoelectric conversion element 311.

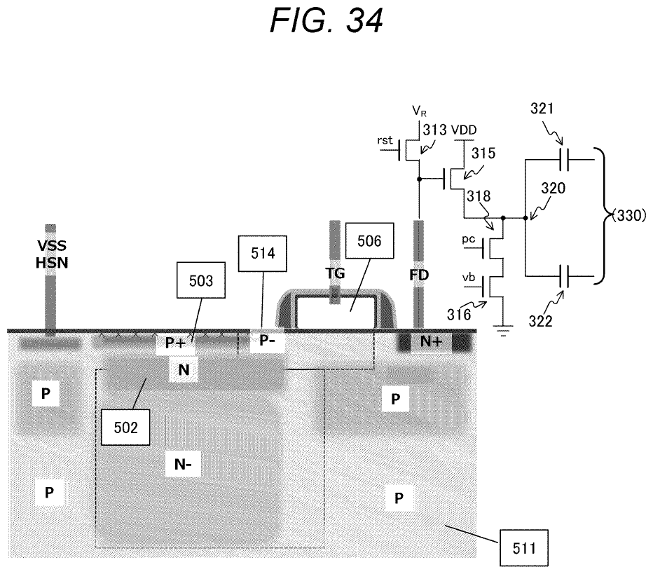

FIG. 34 is a diagram illustrating a configuration example of a photoelectric conversion element 311 according to the third embodiment of the present technology. An n-type region that is a charge storage section 502 of the photodiode (photoelectric conversion element 311) is embedded in a substrate 511. An interface between silicon and a silicon oxide film is covered with a high-concentration p-layer 503, and it is possible to suppress white spots and dark currents by separating it in a Sip-type region 503 having many crystal defects. However, when the p-type concentration of a peripheral portion 514 of a TG electrode 506 is too high, it becomes difficult to read out a signal, and thus it is necessary to reduce the p-type concentration only in the region of 514. In this case, by providing a negative bias (for example, −1.2 V) when the TG electrode 506 is off, the entire surface can be filled with holes, and dark currents can be reduced.

As illustrated in the drawing, by using the photodiode in which a charge storage region is embedded in a semiconductor substrate (the substrate 511), dark currents can be suppressed, and image quality in a dark place can be improved.

Note that, in Non-Patent Document 1, since a photoelectric conversion current of the photodiode is used and the embedded structure illustrated in the drawing cannot be adopted, it is difficult to improve the image quality in a dark place.

Furthermore, the modification of the first embodiment, and the second embodiment can be applied to the third embodiment.

As described above, according to the third embodiment of the present technology, since the photodiode in which the charge storage region is embedded in the semiconductor substrate (substrate 511) is used, image quality in a dark place can be improved.

### 4. Fourth Embodiment

In the first embodiment described above, one system of post-stage circuits is provided for each pixel, but in this configuration, the reading speed may be insufficient. A solid-state imaging element 200 in the fourth embodiment is different from that in the first embodiment in that two systems of post-stage circuits are provided for each pixel.

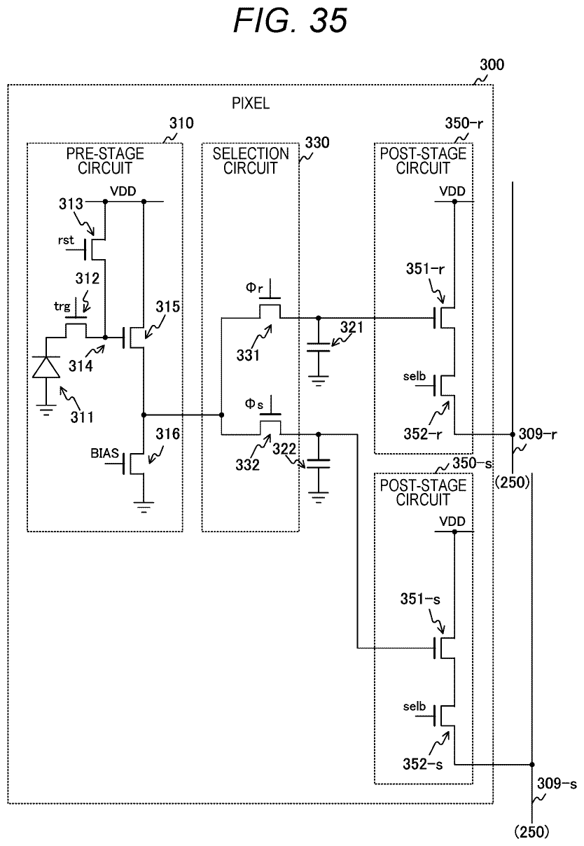

FIG. 35 is a circuit diagram illustrating a configuration example of a pixel 300 according to the fourth embodiment of the present technology. The pixel 300 of the fourth embodiment includes post-stage circuits 350-r and 350-s instead of the post-stage circuit 350.

A selection transistor 331 opens and closes a path between a capacitive element 321 and the post-stage circuit 350-r, and a selection transistor 332 opens and closes a path between a capacitive element 322 and the post-stage circuit 350-s.

The post-stage circuit 350-r includes a post-stage amplification transistor 351-r and a post-stage selection transistor 352-r, and the post-stage circuit 350-s includes a post-stage amplification transistor 351-s and a post-stage selection transistor 352-s. Furthermore, two vertical signal lines are wired for each column. The post-stage circuit 350-r outputs the reset level to a vertical signal line 309-r, and the post-stage circuit 350-s outputs the signal level to a vertical signal line 309-s. The reset level and the signal level are simultaneously output.

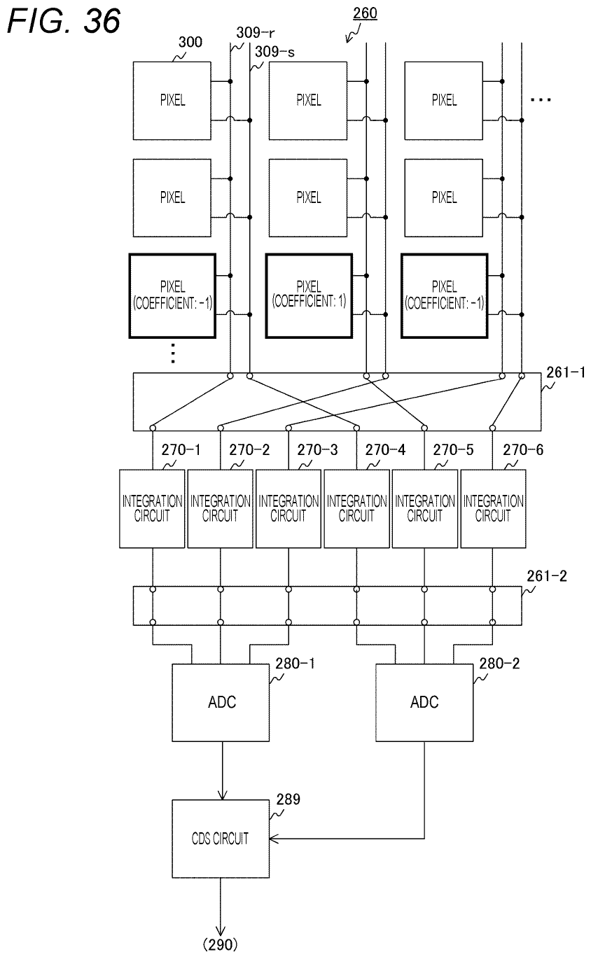

FIG. 36 is a circuit diagram illustrating a configuration example of a column signal processing circuit 260 according to the fourth embodiment of the present technology. The number of each of the integration circuits and the ADCs is twice that of the first embodiment. For example, assuming that the size of the filter is 3 rows×3 columns, six integration circuits such as integration circuits 270-1 to 270-6 and two ADCs such as ADCs 280-1 and 280-2 are disposed every three columns. Furthermore, a CDS circuit 289 is further disposed every three columns.

Furthermore, switching circuits 261-1 and 261-2 are disposed instead of the switching circuit 261. The switching circuit 261-1 switches a connection destination of the vertical signal line, and the switching circuit 261-2 switches a connection destination of the integration circuit.

For example, the switching circuit 261-2 is assumed to connect output destinations of the integration circuits 270-1, 270-2, and 270-3 to the ADC 280-1, and connect output destinations of the integration circuits 270-4, 270-5, and 270-6 to the ADC 280-2. Furthermore, these ADCs do not perform CDS processing and perform only AD conversion.

The CDS circuit 289 subtracts a digital signal output from the ADC 280-2 from a digital signal output from the ADC 280-1, and supplies the subtracted digital signal to an image recognition section 290.

The switching circuit 261-1 switches the connection destination of the vertical signal line according to the sign of the filter coefficient of the pixel. For example, focusing on a certain row in the filter, it is assumed that the filter coefficient in the first column from the left of the row is −1, the filter coefficient in the second column is +1, and the filter coefficient in the third column is −1. In this case, the switching circuit 261-1 connects to the integration circuit 270-1 the vertical signal line (such as 309-r) that transmits the reset level of the first column, and connects to the integration circuit 270-4 the vertical signal line (such as 309-s) that transmits the signal level of the column.

Furthermore, the switching circuit 261-1 connects to the integration circuit 270-5 the vertical signal line that transmits the reset level of the second column, and connects to the integration circuit 270-2 the vertical signal line that transmits the signal level of the column. The switching circuit 261-1 connects to the integration circuit 270-3 the vertical signal line that transmits the reset level of the third column, and connects to the integration circuit 270-6 the vertical signal line that transmits the signal level of the column.

With the configuration illustrated in the drawing, the AD conversion of the reset level of each pixel and the AD conversion of the signal level can be executed in parallel. Therefore, the reading speed can be improved.

Furthermore, the modification of the first embodiment, and the second and third embodiments can be applied to the fourth embodiment.

As described above, according to the fourth embodiment of the present technology, the post-stage circuits 350-r and 350-s simultaneously output the reset level and the signal level, and the ADCs 280-1 and 280-2 simultaneously perform AD conversion thereof, so that the reading speed can be improved.

### 5. Fifth Embodiment

In the first embodiment described above, the precharge transistor 318 is provided in the pixel 300, but this transistor can be reduced. A solid-state imaging element 200 in the fifth embodiment is different from that in the first embodiment in that the precharge transistor 318 is reduced.

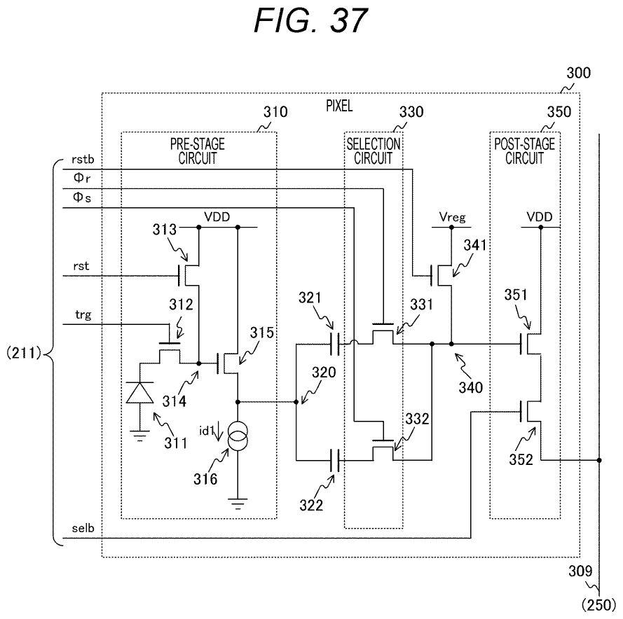

FIG. 37 is a circuit diagram illustrating a configuration example of a pixel 300 according to the fifth embodiment of the present technology. The pixel 300 of the fifth embodiment is different from that of the first embodiment in that the precharge transistor 318 is reduced. A vertical scanning circuit 211 is only required to turn off a current source transistor 316 instead of the precharge transistor 318 by controlling the gate voltage to prevent charge loss.

Furthermore, the modification of the first embodiment, and the second to fourth embodiments can be applied to the fifth embodiment.

As described above, according to the fourth embodiment of the present technology, since the precharge transistor 318 is reduced, the circuit scale of the solid-state imaging element 200 can be reduced accordingly.

### [First Modification]

In the above-described fifth embodiment, the pre-stage circuit 310 reads a signal while being connected to the pre-stage node 320, but with this configuration, noise from the pre-stage node 320 cannot be cut off at the time of reading. The pixel 300 according to a first modification of the fifth embodiment is different from that of the first embodiment in that a transistor is inserted between the pre-stage circuit 310 and the pre-stage node 320.

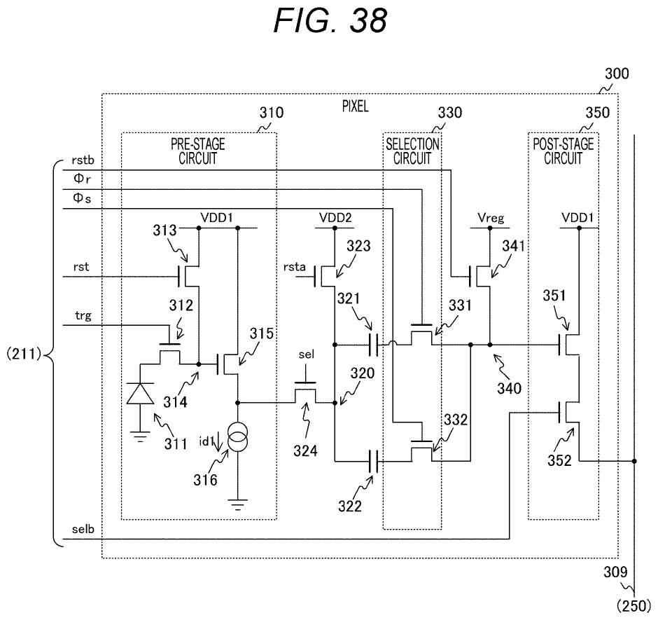

FIG. 38 is a circuit diagram illustrating a configuration example of the pixel 300 in the first modification of the fifth embodiment of the present technology. The pixel 300 according to the first modification of the fifth embodiment is different from that of the fifth embodiment in further including a pre-stage reset transistor 323 and a pre-stage selection transistor 324. Furthermore, power supply voltages of the pre-stage circuit 310 and the post-stage circuit 350 of the first modification of the fifth embodiment are VDD1.

The pre-stage reset transistor 323 initializes the level of the pre-stage node 320 with a power supply voltage VDD2. It is desirable that the power supply voltage VDD2 be set to a value satisfying the following formula.

VDD2=VDD1−Vgs Formula 5

In the above formula, Vgs indicates a gate-source voltage of the pre-stage amplification transistor 315.

By setting the value satisfying Formula 5, it is possible to reduce the potential fluctuation between the pre-stage node 320 and the post-stage node 340 in the dark. It is therefore possible to improve photo response non-uniformity (PRNU). The pre-stage selection transistor 324 opens and closes a path between the pre-stage circuit 310 and the pre-stage node 320 in accordance with a pre-stage selection signal sel from the vertical scanning circuit 211.

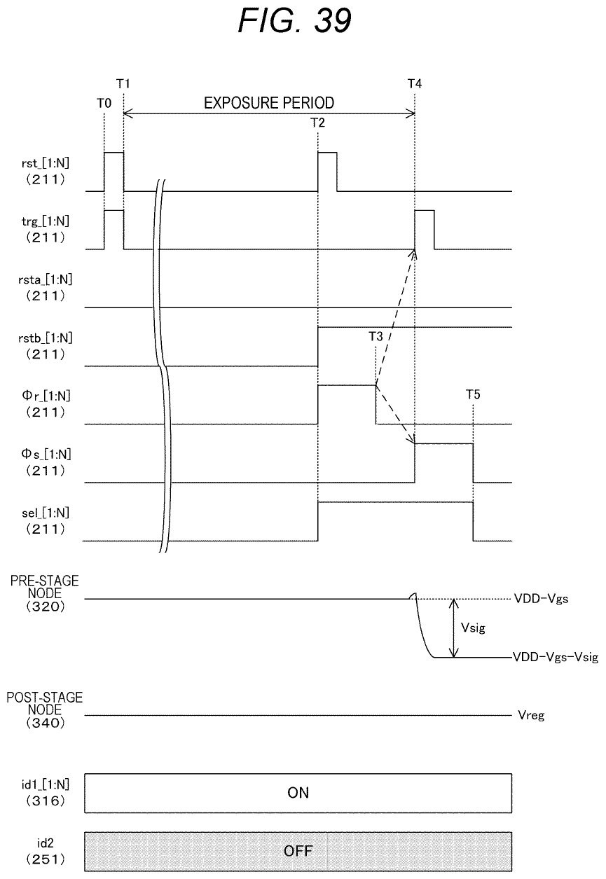

FIG. 39 is a timing chart illustrating an example of a global shutter operation in the first modification of the fifth embodiment of the present technology. The timing chart of the first modification of the fifth embodiment is different from that of the first embodiment in that the vertical scanning circuit 211 further supplies a pre-stage reset signal rsta and the pre-stage selection signal sel. In the drawing, rsta_[n] and sel_[n] indicate signals to pixels in the n-th row.

The vertical scanning circuit 211 supplies a high-level pre-stage selection signal sel to all the pixels over a period from timing T2 immediately before the end of exposure to timing T5. The pre-stage reset signal rsta is controlled to the low level.

Furthermore, the pre-stage selection signal sel is controlled to the low level at the time of reading each row. This control brings the pre-stage selection transistor 324 into the open state to disconnect the pre-stage node 320 from the pre-stage circuit 310. It is therefore possible to block noise from the pre-stage node 320 at the time of reading.

As described above, according to the first modification of the fifth embodiment of the present technology, the pre-stage selection transistor 324 shifts to the open state at the time of reading, and the pre-stage circuit 310 is disconnected from the pre-stage node 320, so that noise from the pre-stage circuit 310 can be cut off.

### [Second Modification]

In the above-described fifth embodiment, the circuits in the solid-state imaging element 200 is provided on a single semiconductor chip. However, in this configuration, when the pixel 300 is miniaturized, the elements may not fit in the semiconductor chip. A solid-state imaging element 200 according to a second modification of the fifth embodiment is different from that of the fifth embodiment in that circuits in the solid-state imaging element 200 are dispersedly disposed on two semiconductor chips.

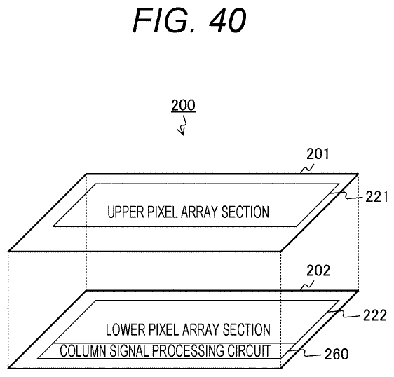

FIG. 40 is a diagram illustrating an example of a stacked structure of the solid-state imaging element 200 in the second modification of the fifth embodiment of the present technology. The solid-state imaging element 200 according to the second modification of the fifth embodiment includes a circuit chip 202 and a pixel chip 201 stacked on the circuit chip 202. These chips are electrically connected by, for example, Cu—Cu bonding. Note that, in addition to the Cu—Cu bonding, the connection can be made using a via or a bump.

An upper pixel array section 221 is disposed in the pixel chip 201. A lower pixel array section 222 and the column signal processing circuit 260 are disposed in the circuit chip 202. For each pixel in the pixel array section 220, a part of the pixel is disposed in the upper pixel array section 221, and the rest is disposed in the lower pixel array section 222.

Furthermore, in the circuit chip 202, the vertical scanning circuit 211, the timing control circuit 212, the DAC 213, and the load MOS circuit block 250 are also disposed. These circuits are not illustrated in the drawing.

Furthermore, the pixel chip 201 is manufactured, for example, by a pixel-dedicated process, and the circuit chip 202 is manufactured, for example, by a complementary MOS (CMOS) process.

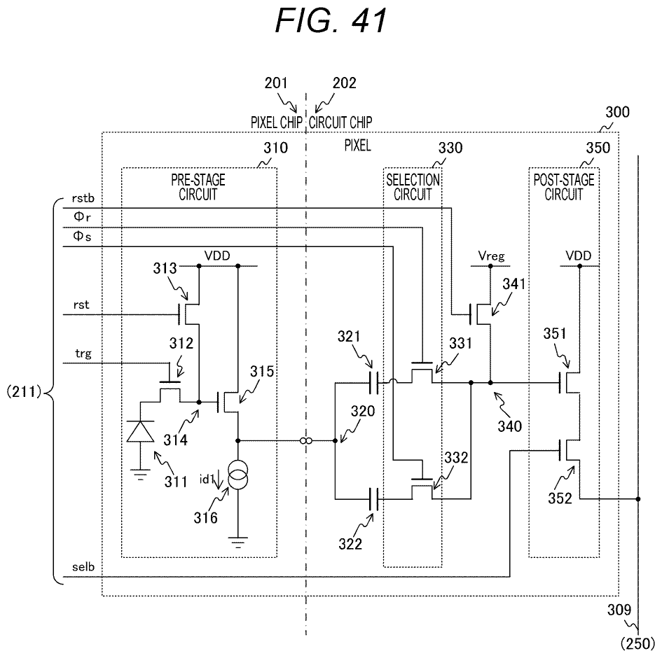

FIG. 41 is a circuit diagram illustrating a configuration example of the pixel 300 in the second modification of the fifth embodiment of the present technology. In the pixel 300, the pre-stage circuit 310 is disposed on the pixel chip 201, and other circuits and elements (such as the capacitive elements 321 and 322) are disposed on the circuit chip 202. Note that the current source transistor 316 can be further disposed in the circuit chip 202. As illustrated in the drawing, by dispersedly disposing the elements in the pixel 300 on the stacked pixel chip 201 and circuit chip 202, an area of the pixel can be reduced, and miniaturization of the pixel is facilitated.

As described above, according to the second modification of the fifth embodiment of the present technology, since the circuits and elements in the pixel 300 are dispersedly disposed on the two semiconductor chips, miniaturization of the pixel is facilitated.

### [Third Modification]

In the second modification of the fifth embodiment described above, a part of the pixel 300 and the peripheral circuit (such as the column signal processing circuit 260) are provided in the lower circuit chip 202. However, with this configuration, an arrangement area of the circuits and elements on the circuit chip 202 side is larger than that of the pixel chip 201 by the peripheral circuit, and there is a possibility that an unnecessary space without circuits and elements is generated in the pixel chip 201. A solid-state imaging element 200 according to a third modification of the fifth embodiment is different from the second modification of the fifth embodiment in that circuits in the solid-state imaging element 200 are dispersedly disposed on three semiconductor chips.

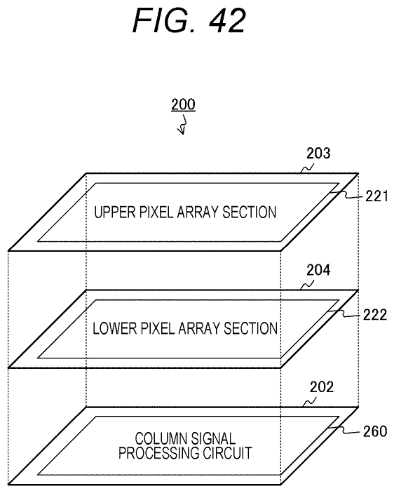

FIG. 42 is a diagram illustrating an example of a stacked structure of the solid-state imaging element 200 in the third modification of the fifth embodiment of the present technology. The solid-state imaging element 200 according to the third modification of the fifth embodiment includes an upper pixel chip 203, a lower pixel chip 204, and a circuit chip 202. These chips are stacked and are electrically connected by, for example, Cu—Cu bonding. Note that, in addition to the Cu—Cu bonding, the connection can be made using a via or a bump.

The upper pixel array section 221 is disposed in the upper pixel chip 203. The lower pixel array section 222 is disposed in the lower pixel chip 204. For each pixel in the pixel array section 220, a part of the pixel is disposed in the upper pixel array section 221, and the rest is disposed in the lower pixel array section 222.

Furthermore, in the circuit chip 202, the column signal processing circuit 260, the vertical scanning circuit 211, the timing control circuit 212, the DAC 213, and the load MOS circuit block 250 are disposed. Circuits other than the column signal processing circuit 260 are not illustrated in the drawing.

Adopting the three-layer configuration as illustrated in the drawing allows a reduction in unnecessary space and allows further pixel miniaturization as compared with the two-layer configuration. Furthermore, the lower pixel chip 204 that is a second layer can be manufactured by a dedicated process for the capacitor and switch.

As described above, in the third modification of the fifth embodiment of the present technology, since the circuits in the solid-state imaging element 200 are dispersedly disposed on the three semiconductor chips, the pixels can be further miniaturized as compared with a case where the circuits are dispersedly disposed on the two semiconductor chips.

### 6. Sixth Embodiment

In the fifth embodiment described above, the reset level is sampled and held in the exposure period, but in this configuration, the exposure period cannot be made shorter than the sample and hold period of the reset level. A solid-state imaging element 200 of a sixth embodiment is different from that of the fifth embodiment in that an exposure period is further shortened by adding a transistor that discharges a charge from a photoelectric conversion element.

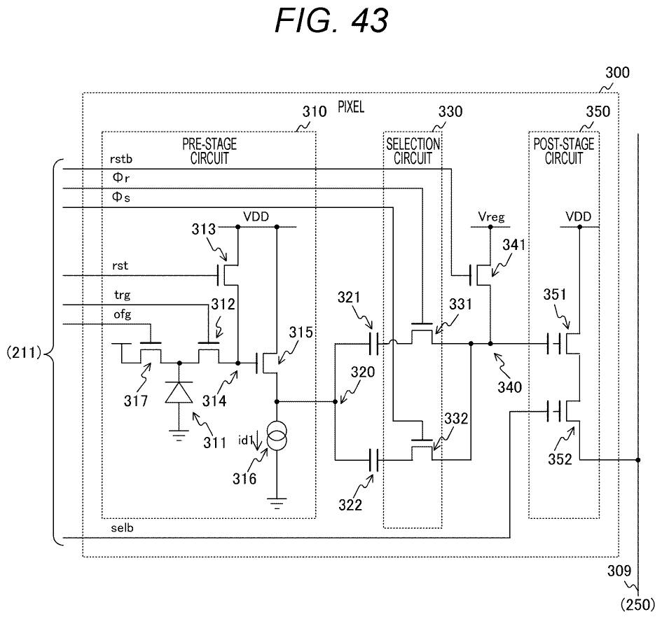

FIG. 43 is a circuit diagram illustrating a configuration example of a pixel 300 according to the sixth embodiment of the present technology. The pixel 300 of the second embodiment is different from that of the fifth embodiment in that a discharge transistor 317 is further provided in a pre-stage circuit 310.

The discharge transistor 317 functions as an overflow drain that discharges a charge from the photoelectric conversion element 311 in accordance with a discharge signal ofg from the vertical scanning circuit 211. As the discharge transistor 317, for example, an nMOS transistors is used.

In a configuration in which the discharge transistor 317 is not provided as in the fifth embodiment, blooming may occur when charges are transferred from the photoelectric conversion element 311 to the FD 314 for all pixels. Then, at the time of FD reset, the potential of the FD 314 and the potential of the pre-stage node 320 drop. In response to the potential drop, charging and discharging currents of the capacitive elements 321 and 322 continue to occur, and IR drop in the power supply or the ground changes from a steady state without blooming.

On the other hand, at the time of sampling and holding the signal levels of all the pixels, after the transfer of the signal charges, the photoelectric conversion element 311 has no charge, so that blooming does not occur, and IR drop in the power supply or the ground goes into the steady state without blooming. Due to a difference in IR drop at the time of sampling and holding the reset level and the signal level, streaking noise occurs.

On the other hand, in the sixth embodiment in which the discharge transistor 317 is provided, the charges in the photoelectric conversion element 311 are discharged toward a side of the overflow drain. Therefore, IR drops at the time of sampling and holding the reset level and the signal level become almost identical to each other, so that it is possible to suppress streaking noise.

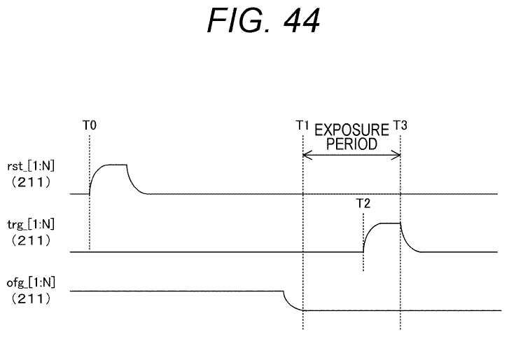

FIG. 44 is a timing chart illustrating an example of a global shutter operation according to the sixth embodiment of the present technology. At timing TO before the start of exposure, the vertical scanning circuit 211 supplies the high-level FD reset signal rst to all the pixels over the pulse period while setting the discharge signal ofg to the high level for all the pixels. Therefore, the PD reset and the FD reset are performed on all the pixels. Furthermore, the reset level is sampled and held. Here, ofg_[n] in the drawing indicates signals to pixels in the n-th row of the N rows.

Then, at timing T1 that is the start of exposure, the vertical scanning circuit 211 returns the discharge signal ofg to the low level for all the pixels. Then, the vertical scanning circuit 211 supplies the high-level transfer signal trg to all the pixels over a period from timing T2 immediately before the end of exposure to timing T3 that is the end of exposure. As a result, the signal level is sampled and held.

In the configuration in which the discharge transistor 317 is not provided as in the fifth embodiment, both the transfer transistor 312 and the FD reset transistor 313 need to be turned on at the start of exposure (that is, at the time of PD reset). Under this control, the FD 314 also needs to be reset at the time of PD reset. It is therefore necessary to perform the FD reset again within the exposure period to sample and hold the reset level, so that the exposure period cannot be made shorter than the sample and hold period of the reset level. When the reset levels of all the pixels are sampled and held, a certain waiting time is required until the voltage and the current settle, and for example, a sample and hold period of several microseconds (μs) to several tens of microseconds (μs) is required.

On the other hand, in the sixth embodiment in which the discharge transistor 317 is provided, the PD reset and the FD reset can be separately performed. Therefore, as illustrated in the drawing, it is possible to sample and hold the reset level by performing the FD reset before cancellation of the PD reset (the start of exposure). It is therefore possible to make the exposure period shorter than the sample and hold period of the reset level.

Note that the first to third modifications of the fifth embodiment can also be applied to the sixth embodiment.

As described above, according to the sixth embodiment of the present technology, since the discharge transistor 317 that discharges a charge from the photoelectric conversion element 311 is provided, it is possible to sample and hold the reset level by performing the FD reset before the start of exposure. It is therefore possible to make the exposure period shorter than the sample and hold period of the reset level.

### 7. Seventh Embodiment

In the above-described fifth embodiment, the FD 314 is initialized by the power supply voltage VDD. However, in this configuration, there is a possibility that photo response non-uniformity (PRNU) deteriorates due to variations in the capacitive elements 321 and 322 and parasitic capacitance. A solid-state imaging element 200 of the seventh embodiment is different from that of the fifth embodiment in improving the PRNU by lowering the power supply of the FD reset transistor 313 at the time of reading.

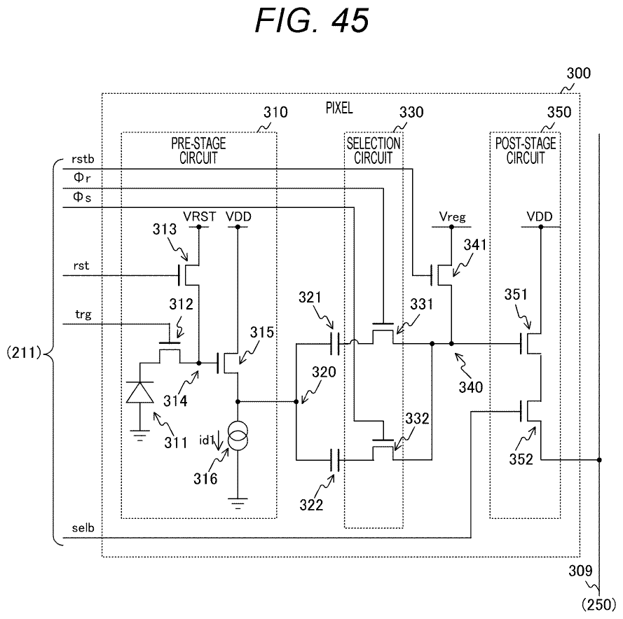

FIG. 45 is a circuit diagram illustrating a configuration example of a pixel 300 according to the seventh embodiment of the present technology. The pixel 300 of this seventh embodiment is different from the pixel 300 of the first embodiment in that the power supply of the FD reset transistor 313 is separated from the power supply voltage VDD of the pixel 300.

The FD reset transistor 313 of the seventh embodiment has a drain connected to a reset power supply voltage VRST. The reset power supply voltage VRST is controlled by, for example, the timing control circuit 212.

Here, deterioration of the PRNU in the pixel 300 according to the fifth embodiment will be considered. In the first embodiment, at timing TO immediately before the exposure start time, the potential of the FD 314 decreases due to the reset feedthrough of the FD reset transistor 313. An amount of this variation is denoted as Vft.

In the first embodiment, since the power supply voltage of the FD reset transistor 313 is VDD, the potential of the FD 314 varies from VDD to VDD−Vft at timing TO. Furthermore, the potential of the pre-stage node 320 at the time of exposure is VDD−Vft−Vgs.

Furthermore, in the first embodiment, the FD reset transistor 313 shifts to the on state at the time of reading, and the FD 314 is fixed to the power supply voltage VDD. Due to the variation Vft of the FD 314, the potential of the pre-stage node 320 and the potential of the post-stage node 340 at the time of reading are shifted higher by approximately Vft. However, due to variations in capacitance values of the capacitive elements 321 and 322 or parasitic capacitance, the shift voltage amount varies for each pixel, which causes deterioration of PRNU.

A shift amount of the post-stage node 340 in a case where the pre-stage node 320 is shifted by Vft is expressed by, for example, the following formula.

$$\{ ( Cs + δ Cs ) / ( Cs + δ Cs + Cp ) \} * Vft \qquad Formula 6$$

In the above formula, Cs is a capacitance value of the capacitive element 322 on the signal level side, and δCs is a variation in Cs. Cp is a capacitance value of the parasitic capacitance of the post-stage node 340.

Formula 6 can be approximated by the following formula.

$$\{ 1 - ( δ Cs / Cs ) * ( Cp / Cs ) \} * Vft \qquad Formula 7$$

From Formula 7, the variation in the post-stage node 340 can be expressed by the following formula.

$$\{ ( δ Cs / Cs ) * ( Cp / Cs ) \} * Vft \qquad Formula 8$$

With (δCs/Cs) set to 10⁻², (Cp/Cs) set to 10⁻¹, and Vft set to 400 millivolt (mV), PRNU is 400 μVrms according to Formula 8, which is a relatively large value.

In particular, in order to reduce kTC noise at the time of sampling and holding input conversion capacitance, it is necessary to increase a charge-voltage conversion efficiency of the FD 314. In order to increase the charge-voltage conversion efficiency, it is necessary to reduce the capacitance of the FD 314, but the smaller the capacitance of the FD 314, the larger the variation Vft, which may be several hundred millivolts (mV). In this case, the influence of the PRNU can be at a non-negligible level from Formula 8.

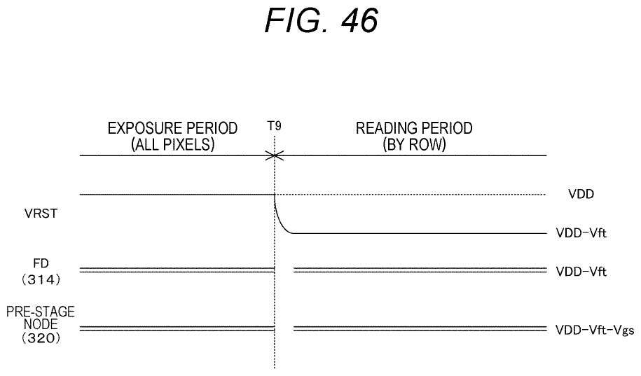

FIG. 46 is a timing chart illustrating an example of voltage control according to the seventh embodiment of the present technology.

The timing control circuit 212 performs control to make the reset power supply voltage VRST for the row-by-row reading period after timing T9 different from the reset power supply voltage VRST for the exposure period.

For example, for the exposure period, the timing control circuit 212 sets the reset power supply voltage VRST identical to the power supply voltage VDD. On the other hand, for the reading period, the timing control circuit 212 decreases the reset power supply voltage VRST to VDD-Vft. That is, for the reading period, the timing control circuit 212 decreases the reset power supply voltage VRST by amount approximately equal to the variation Vft caused by reset feedthrough. This control allows the reset level of the FD 314 at the time of exposure and the reset level at the time of reading to be identical to each other.

Controlling the reset power supply voltage VRST allows, as illustrated in the drawing, a reduction in variations in voltage of the FD 314 and the pre-stage node 320. It is therefore possible to suppress variations of the capacitive elements 321 and 322 and deterioration of PRNU due to parasitic capacitance.

Note that the first to third modifications of the fifth embodiment, and the sixth embodiment can also be applied to the seventh embodiment.

As described above, according to the seventh embodiment of the present technology, since the timing control circuit 212 decreases the reset power supply voltage VRST by the variation Vft caused by reset feedthrough at the time of reading, it is possible to make the reset level at the time of exposure and the reset level at the time of reading identical to each other. It is therefore possible to suppress deterioration of photo response non-uniformity (PRNU).

### 8. Eighth Embodiment

In the above-described fifth embodiment, the vertical scanning circuit 211 performs control (that is, global shutter operation) to simultaneously expose all rows (all pixels). In a case where the simultaneity of exposure is not required, but low noise is required, such as at the time of test or analysis, it is, however, desirable to perform a rolling shutter operation. A solid-state imaging element 200 of the eighth embodiment is different from that of the fifth embodiment in that a rolling shutter operation is performed at the time of a test or the like.

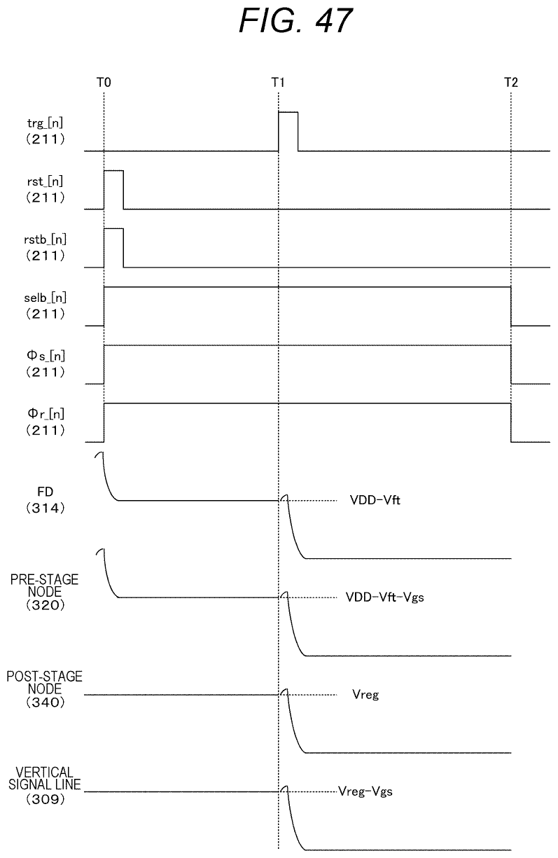

FIG. 47 is a timing chart illustrating an example of rolling shutter operation according to the eighth embodiment of the present technology. The vertical scanning circuit 211 performs control to sequentially select a plurality of rows and start exposure. This drawing illustrates exposure control of the n-th row.

Over a period from timing T0 to timing T2, the vertical scanning circuit 211 supplies the high-level post-stage selection signal selb, the high-level selection signal ør, and the high-level selection signal os to the n-th row. Furthermore, at timing TO that is the start of exposure, the vertical scanning circuit 211 supplies the high-level FD reset signal rst and the high-level post-stage reset signal rstb to the n-th row over the pulse period. At timing T1 that is the end of exposure, the vertical scanning circuit 211 supplies the transfer signal trg to the n-th row. The rolling shutter operation in the drawing allows the solid-state imaging element 200 to generate low-noise image data.

Note that the solid-state imaging element 200 according to the eighth embodiment performs the global shutter operation similarly to the fifth embodiment except during the test.

Furthermore, the first to third modifications of the fifth embodiment, and the sixth and seventh embodiments can also be applied to the eighth embodiment.

As described above, according to the eighth embodiment of the present technology, the vertical scanning circuit 211 performs control (that is, rolling shutter operation) to sequentially select a plurality of rows and start exposure, and thus, it is possible to generate low-noise image data.

### 9. Ninth Embodiment

In the above-described fifth embodiment, a source of a pre-stage source follower (the pre-stage amplification transistor 315 and the current source transistor 316) is connected to the power supply voltage VDD, and reading is performed in units of rows in a state where the source follower is turned on. There is, however, a possibility that this driving method causes circuit noise of the pre-stage source follower at the time of row-by-row reading to propagate to the subsequent stages, and random noise increases accordingly. A solid-state imaging element 200 of the ninth embodiment is different from that of the fifth embodiment in that noise is reduced by turning off the pre-stage source follower at the time of reading.

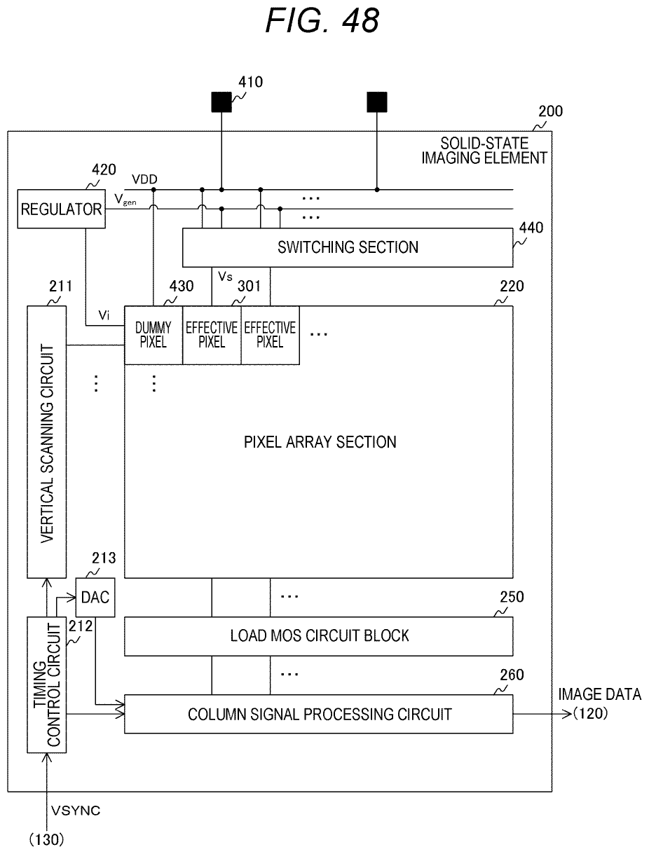

FIG. 48 is a block diagram illustrating a configuration example of the solid-state imaging element 200 according to the ninth embodiment of the present technology. The solid-state imaging element 200 of the ninth embodiment is different from that of the fifth embodiment in further including a regulator 420 and a switching section 440. Furthermore, in the pixel array section 220 of the seventh embodiment, a plurality of effective pixels 301 and a predetermined number of dummy pixels 430 are arranged. The dummy pixels 430 are arranged around a region where the effective pixels 301 are arranged.

Furthermore, the power supply voltage VDD is supplied to each of the dummy pixels 430, and the power supply voltage VDD and a source voltage Vs are supplied to each of the effective pixels 301. The signal lines for supplying the power supply voltage VDD to the effective pixels 301 are not illustrated in the drawing. Furthermore, the power supply voltage VDD is supplied from a pad 410 located outside the solid-state imaging element 200.

The regulator 420 generates a constant generation voltage Vgen on the basis of an input voltage Vi from the dummy pixels 430, and supplies the generation voltage Vgen to the switching section 440. The switching section 440 selects either the power supply voltage VDD from the pad 410 or the generation voltage Vgen from the regulator 420, and supplies the selected voltage as the source voltage Vs to each of the columns of the effective pixels 301.

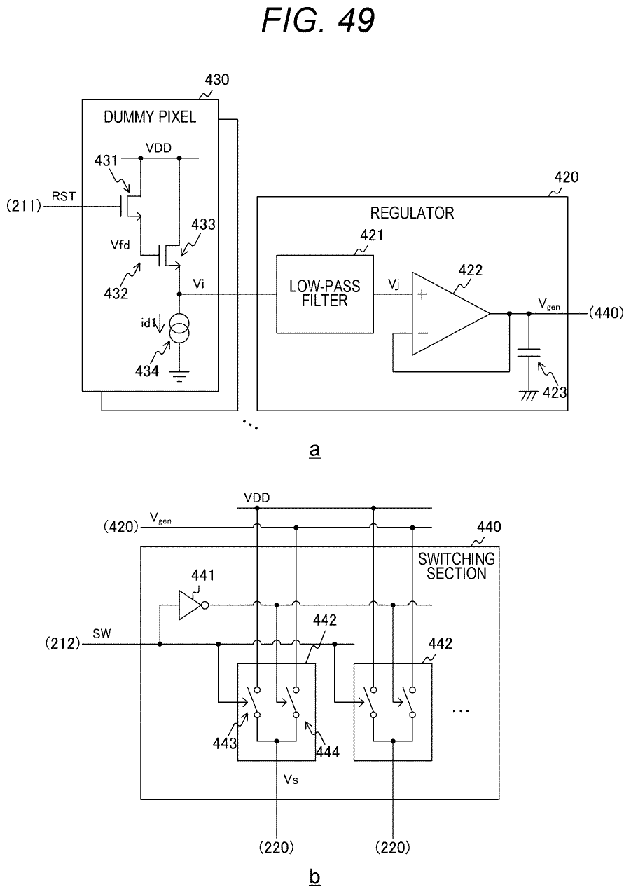

FIG. 49 is a circuit diagram illustrating a configuration example of the dummy pixel 430, the regulator 420, and the switching section 440 according to the ninth embodiment of the present technology. Of the drawing, a indicates a circuit diagram of the dummy pixel 430 and the regulator 420, and b of the drawing indicates a circuit diagram of the switching section 440.

As illustrated in a of the drawing, the dummy pixel 430 includes a reset transistor 431, an FD 432, an amplification transistor 433, and a current source transistor 434. The reset transistor 431 initializes the FD 432 in accordance with a reset signal RST from the vertical scanning circuit 211. The FD 432 accumulates charges, and generates a voltage according to a charge amount. The amplification transistor 433 amplifies a level of a voltage of the FD 432 and supplies the amplified voltage as the input voltage Vi to the regulator 420.

Furthermore, the FD reset transistor 431 and the amplification transistor 433 have their respective sources connected to the power supply voltage VDD. The current source transistor 434 is connected to a drain of the amplification transistor 433. The current source transistor 434 supplies the current id1 under the control of the vertical scanning circuit 211.

The regulator 420 includes a low-pass filter 421, a buffer amplifier 422, and a capacitive element 423. The low-pass filter 421 passes, as an output voltage Vj, a component in a low-frequency band below a predetermined frequency out of a signal of the input voltage Vi.

The output voltage Vj is input to a non-inverting input terminal (+) of the buffer amplifier 422. An inverting input terminal (−) of the buffer amplifier 422 is connected to an output terminal thereof. The capacitive element 423 holds a voltage of the output terminal of the buffer amplifier 422 as Vgen. This Vgen is supplied to the switching section 440.

As illustrated in b of the drawing, the switching section 440 includes an inverter 441 and a plurality of switching circuits 442. The switching circuits 442 are each disposed for a corresponding one of the columns of the effective pixels 301.

The inverter 441 inverts a switching signal SW sent from the timing control circuit 212. The inverter 441 supplies the inverted signal to each of the switching circuits 442.

The switching circuits 442 each select either the power supply voltage VDD or the generation voltage Vgen, and supplies the selected voltage as the source voltage Vs to the corresponding column in the pixel array section 220. The switching circuits 442 each include switches 443 and 444. The switch 443 opens and closes a path between the node of the power supply voltage VDD and the corresponding column, in accordance with the switching signal SW. The switch 444 opens and closes a path between the node of the generation voltage Vgen and the corresponding column, in accordance with an inverted signal of the switching signal SW.

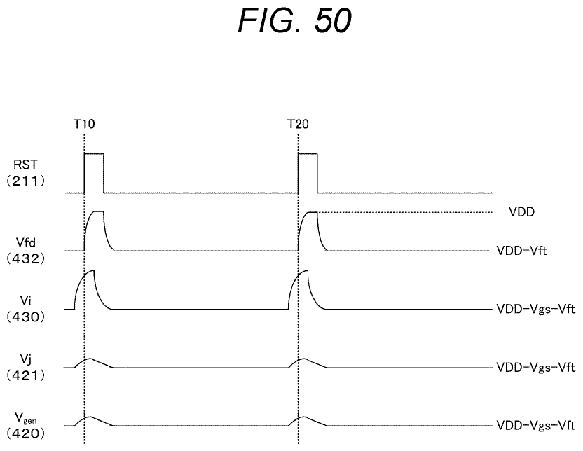

FIG. 50 is a timing chart illustrating an example of an operation of the dummy pixels 430 and the regulator 420 according to the ninth embodiment of the present technology. At timing T10 immediately before reading of a certain row, the vertical scanning circuit 211 supplies a high-level reset signal RST (here, the power supply voltage VDD) to each of the dummy pixels 430. A potential Vfd of the FD 432 in the dummy pixel 430 is initialized to the power supply voltage VDD. Then, when the reset signal RST becomes the low level, reset feedthrough causes a change to VDD−Vft.

Furthermore, the input voltage Vi decreases to VDD−Vgs−Vsig after the reset. By passing through the low-pass filter 421, Vj and Vgen turn into voltages that are almost constant.

After timing T20 immediately before reading of the next row, similar control is performed for each row, and the constant generation voltage Vgen is supplied.

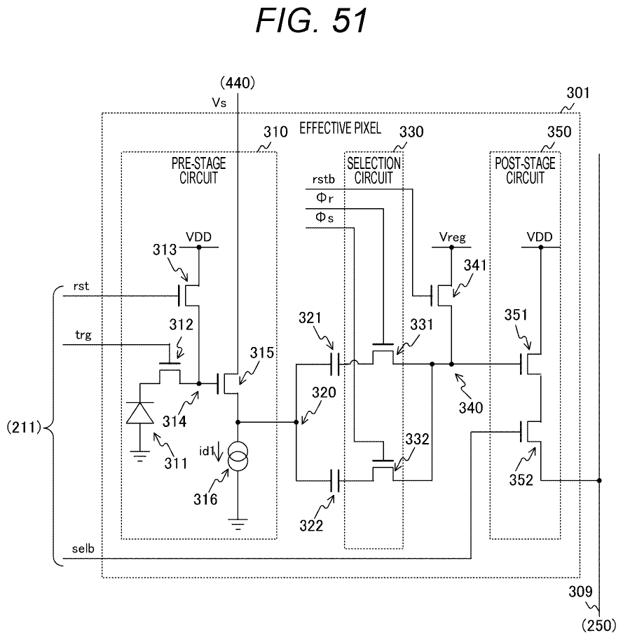

FIG. 51 is a circuit diagram illustrating a configuration example of each of the effective pixels 301 according to the ninth embodiment of the present technology. The circuit configuration of the effective pixel 301 is similar to that of the pixel 300 of the fifth embodiment except that the source voltage Vs from the switching section 440 is supplied to the source of the pre-stage amplification transistor 315.

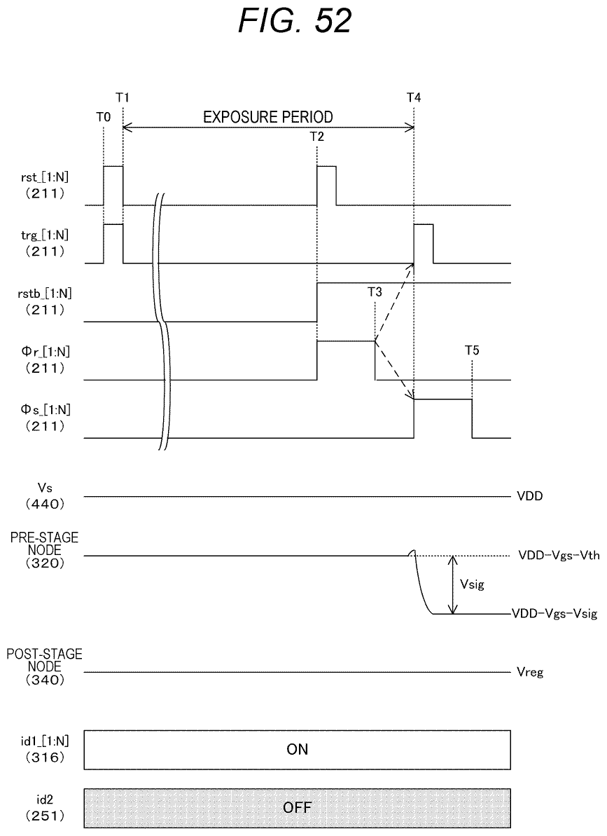

FIG. 52 is a timing chart illustrating an example of a global shutter operation according to the ninth embodiment of the present technology. In the ninth embodiment, when exposure is performed simultaneously in all the pixels, the switching section 440 selects the power supply voltage VDD and supplies the power supply voltage VDD as the source voltage Vs. Furthermore, the voltage of the pre-stage node decreases from VDD−Vgs−Vth to VDD−Vgs−Vsig at timing T4. Here, Vth represents a threshold voltage of the transfer transistor 312.

Furthermore, in the ninth embodiment, at the time of reading, the switching section 440 selects the generation voltage Vgen and supplies the generation voltage Vgen as the source voltage Vs. The generation voltage Vgen is adjusted to VDD-Vgs-Vft.

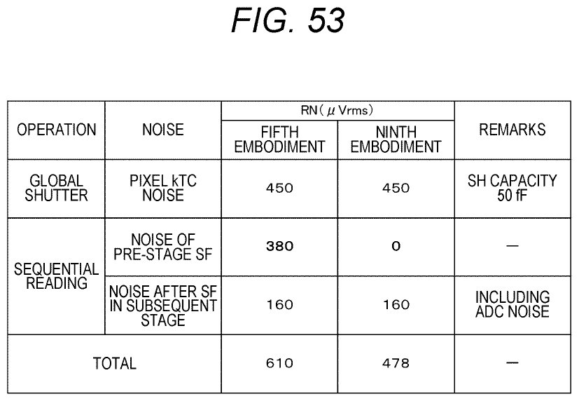

FIG. 53 is a diagram for explaining an effect in the ninth embodiment of the present technology. In the first embodiment, the source follower (the pre-stage amplification transistor 315 and the current source transistor 316) of the pixel 300 to be read is turned on during row-by-row reading. There is, however, a possibility that this driving method causes circuit noise of the pre-stage source follower to propagate to the subsequent stages (capacitive element, and post-stage source follower and ADC), and readout noise increases accordingly.

For example, in the fifth embodiment, as illustrated in the drawing, kTC noise generated in a pixel during a global shutter operation is 450 (μVrms). Furthermore, noise generated in the pre-stage source follower (the pre-stage amplification transistor 315 and the current source transistor 316) during the row-by-row reading is 380 (μVrms). Noise generated after the source follower in the subsequent stage is 160 (μVrms). Therefore, the total noise is 610 (μVrms). As described above, in the fifth embodiment, the contribution of the noise of the pre-stage source follower in the total value of the noise becomes relatively large.

In order to reduce the noise of the pre-stage source follower, in the ninth embodiment, as described above, the voltage (Vs) that can be adjusted is supplied to the source of the pre-stage source follower. During the global shutter (exposure) operation, the switching section 440 selects the power supply voltage VDD and supplies the selected power supply voltage as the source voltage Vs. Then, after the end of exposure, the switching section 440 switches the source voltage Vs to VDD−Vgs−Vft. Furthermore, the timing control circuit 212 turns on the pre-stage current source transistor 316 during the global shutter (exposure) operation, and turns off the pre-stage current source transistor 316 after the end of exposure.

By the above-described control, as described above, the potentials of the pre-stage nodes at the time of the global shutter operation and at the time of reading for each row are the same, and the PRNU can be improved. Furthermore, since the pre-stage source follower is turned off at the time of reading for each row, circuit noise of the source follower does not occur and becomes 0 (μVrms). Note that, in the pre-stage source follower, the pre-stage amplification transistor 315 is in the on state.

As described above, according to the ninth embodiment of the present technology, since the pre-stage source follower is turned off at the time of reading, noise generated in the source follower can be reduced.

### 10. Application Example to Moving Body

The technology (the present technology) according to the present disclosure can be applied to various products. For example, the technology of the present disclosure may be achieved in the form of a device to be mounted on a moving body of any kind, such as an automobile, an electric vehicle, a hybrid electric vehicle, a motorcycle, a bicycle, a personal mobility, an airplane, a drone, a vessel, or a robot.

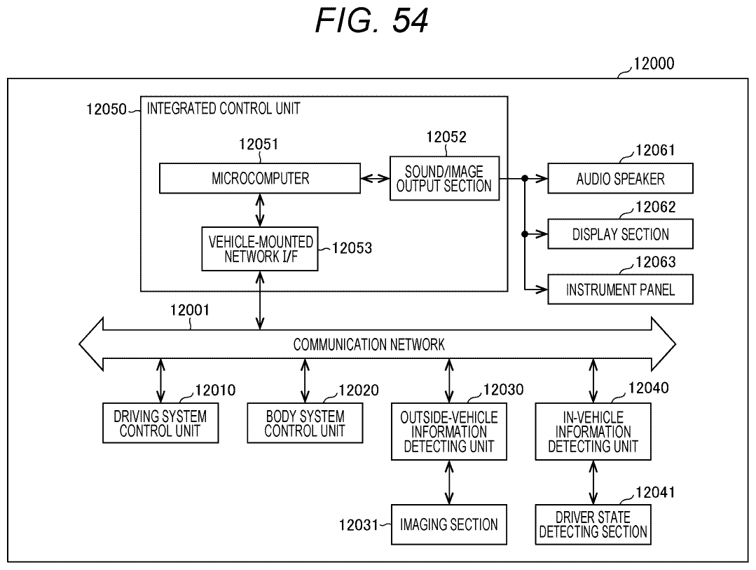

FIG. 54 is a block diagram illustrating a schematic configuration example of a vehicle control system which is an example of a moving body control system to which the technology according to the present disclosure can be applied.

The vehicle control system 12000 includes a plurality of electronic control units connected to each other via a communication network 12001. In the example illustrated in FIG. 54, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 54, an audio speaker 12061, a display section 12062, and an instrument panel 12063 are illustrated as the output device. The display section 12062 may, for example, include at least one of an on-board display and a head-up display.

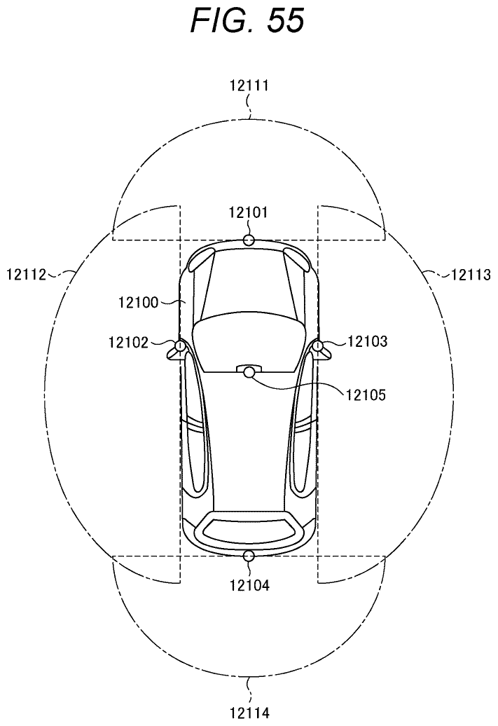

FIG. 55 is a diagram illustrating an example of an installation position of the imaging section 12031.

In FIG. 55, imaging sections 12101, 12102, 12103, 12104, and 12105 are included as the imaging section 12031.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 55 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure may be applied to the imaging section 12031 in the configuration described above. Specifically, for example, the imaging device 100 in FIG. 1 can be applied to the imaging section 12031. By applying the technology according to the present disclosure to the imaging section 12031, the accuracy of the image recognition processing can be improved, so that the safety of the system can be improved.

Note that the embodiments described above show examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments, and can be embodied by applying various modifications to the embodiments without departing from the scope of the present technology.

Note that advantageous effects described in the present description are merely examples and are not limited, and other advantageous effects may be provided.

Note that the present technology may also have the following configurations.

(1) A solid-state imaging element including:
a pixel array section in which a plurality of pixels each generating and holding an analog pixel signal is arranged in a two-dimensional grid pattern;
a plurality of integration circuits that time-integrates the pixel signal held in each of a predetermined number of pixels arranged in a vertical direction among the plurality of pixels and outputs an integration signal; and
an analog-to-digital converter that analog-adds the integration signal of each of the plurality of integration circuits to convert the analog-added integration signal into a digital signal.

(2) The solid-state imaging element according to (1) described above, in which
an integration time for each pixel of the integration circuits includes a time according to an absolute value of a filter coefficient corresponding to the pixel.

(3) The solid-state imaging element according to (2) described above, in which
the pixel signal includes a predetermined reset level and a signal level according to an exposure amount, and the pixel outputs the reset level and the signal level in a predetermined order in a case where a sign of the filter coefficient is positive, and outputs the reset level and the signal level in an order reverse to the predetermined order in a case where the sign of the filter coefficient is negative.

(4) The solid-state imaging element according to any one of (1) to (3) described above, in which
the plurality of integration circuits includes first and second integration circuits, and
the analog-to-digital converter includes:
a first capacitive element including one end connected to the first integration circuit;
a second capacitive element including one end connected to the second integration circuit;
a comparator including two input terminals, one of the two input terminals being connected to another end of each of the first and second capacitive elements; and
a counter that counts a count value over a period until an output signal of the comparator is inverted.

(5) The solid-state imaging element according to (4) described above, in which
the analog-to-digital converter further includes a connection switch that connects the another end of the first capacitive element and the another end of the second capacitive element according to a predetermined switching signal.

(6) The solid-state imaging element according to any one of (1) to (5) described above, in which
each of the pixels includes a photodiode in which a charge storage region is embedded in a predetermined semiconductor substrate.

(7) The solid-state imaging element according to any one of (1) to (6) described above, in which
the pixel signal includes a predetermined reset level and a signal level according to an exposure amount, and
each of the pixels includes:
first and second capacitive elements;
a pre-stage circuit that sequentially generates the reset level and the signal level and causes the first and second capacitive elements to hold the reset level and the signal level, respectively;
a first post-stage circuit that reads and outputs the reset level held in the first capacitive element; and
a second post-stage circuit that reads and outputs the signal level held in the second capacitive element.

(8) The solid-state imaging element according to any one of (1) to (6) described above, in which
the pixel signal includes a predetermined reset level and a signal level according to an exposure amount, and
each of the pixels includes:
first and second capacitive elements;
a pre-stage circuit that sequentially generates the reset level and the signal level and causes the first and second capacitive elements to hold the reset level and the signal level, respectively;
a selection circuit that sequentially performs control to connect one of the first and second capacitive elements to a predetermined post-stage node, control to disconnect both the first and second capacitive elements from the post-stage node, and control to connect another of the first and second capacitive elements to the post-stage node;
a post-stage reset transistor that initializes a level of the post-stage node when both the first and second capacitive elements are disconnected from the post-stage node; and
a post-stage circuit that sequentially reads the reset level and the signal level from the first and second capacitive elements via the post-stage node and outputs the reset level and the signal level.

(9) An imaging device including:
a pixel array section in which a plurality of pixels each generating and holding an analog pixel signal is arranged in a two-dimensional grid pattern;
a plurality of integration circuits that time-integrates the pixel signal held in each of a predetermined number of pixels arranged in a vertical direction among the plurality of pixels and outputs an integration signal;
an analog-to-digital converter that adds the integration signal of each of the plurality of integration circuits to convert the added integration signal into a digital signal; and
an image recognition section that performs predetermined image recognition processing using the digital signal.

(10) A method of controlling a solid-state imaging element, the method including:
a sample and hold procedure in which each of a plurality of pixels arranged in a two-dimensional grid pattern generates and holds an analog pixel signal;
an integration procedure in which a plurality of integration circuits time-integrates the pixel signal held in each of a predetermined number of pixels arranged in a vertical direction among the plurality of pixels and outputs an integration signal; and
an analog-to-digital conversion procedure of analog-adding the integration signal of each of the plurality of integration circuits to convert the analog-added integration signal into a digital signal.

### REFERENCE SIGNS LIST

100 Imaging device
110 Imaging lens
120 Recording section
130 Imaging control section
200 Solid-state imaging element
201 Pixel chip
202 Circuit chip
203 Upper pixel chip
204 Lower pixel chip
211 Vertical scanning circuit
212 Timing control circuit
213 DAC
220 Pixel array section
221 Upper pixel array section
222 Lower pixel array section
250 Load MOS circuit block
251 Load MOS transistor
260 Column signal processing circuit
261, 261-1, 261-2 Switching circuit
262-1 to 262-K, 263-1 to 263-K
270-1 to 270-K Integration circuit
Bypass switch
271 Input switch
272 Resistive element
273 Operational amplifier
274, 281, 282-1 to 282-K, 423 Capacitive element
275, 286 Auto-zero switch
283-1 to 283-(K−1) Connection switch
280-1, 280-2 ADC
285 Comparator
287 Counter
289 CDS circuit
290 Image recognition section
291 CNN processing section
292 Data collation section
300 Pixel
301 Effective pixel
310 Pre-stage circuit
311 Photoelectric conversion element
312 Transfer transistor
313 FD reset transistor
314, 432 FD
315 Pre-stage amplification transistor
316, 434 Current source transistor
317 Discharge transistor
318 Precharge transistor
321, 322 Capacitive element
323 Pre-stage reset transistor
324 Pre-stage selection transistor
330 Selection circuit
331, 332 Selection transistor
341 Post-stage reset transistor
350, 350-r, 350-s Post-stage circuit
351, 351-r, 351-s Post-stage amplification transistor
352, 352-r, 352-s Post-stage selection transistor
420 Regulator
421 Low-pass filter
422 Buffer amplifier
430 Dummy pixel
431 Reset transistor
433 Amplification transistor
440 Switching section
441 Inverter
442 Switching circuit
443, 444 Switch
501, 511 Substrate
502 Charge storage section
503 p layer
504 Silicon-oxide film
505 n+ region
514 Floating electrode
12031 Imaging section

1. A solid-state imaging element comprising:
a pixel array section in which a plurality of pixels each generating and holding an analog pixel signal is arranged in a two-dimensional grid pattern;
a plurality of integration circuits that time-integrates the pixel signal held in each of a predetermined number of pixels arranged in a vertical direction among the plurality of pixels and outputs an integration signal; and
an analog-to-digital converter that analog-adds the integration signal of each of the plurality of integration circuits to convert the analog-added integration signal into a digital signal.

2. The solid-state imaging element according to claim 1, wherein
an integration time for each pixel of the integration circuits includes a time according to an absolute value of a filter coefficient corresponding to the pixel.

3. The solid-state imaging element according to claim 2, wherein
the pixel signal includes a predetermined reset level and a signal level according to an exposure amount, and
the pixel outputs the reset level and the signal level in a predetermined order in a case where a sign of the filter coefficient is positive, and outputs the reset level and the signal level in an order reverse to the predetermined order in a case where the sign of the filter coefficient is negative.

4. The solid-state imaging element according to claim 1, wherein
the plurality of integration circuits includes first and second integration circuits, and
the analog-to-digital converter includes:
a first capacitive element including one end connected to the first integration circuit;
a second capacitive element including one end connected to the second integration circuit;
a comparator including two input terminals, one of the two input terminals being connected to another end of each of the first and second capacitive elements; and
a counter that counts a count value over a period until an output signal of the comparator is inverted.

5. The solid-state imaging element according to claim 4, wherein
the analog-to-digital converter further includes a connection switch that connects the another end of the first capacitive element and the another end of the second capacitive element according to a predetermined switching signal.

6. The solid-state imaging element according to claim 1, wherein
each of the pixels includes a photodiode in which a charge storage region is embedded in a predetermined semiconductor substrate.

7. The solid-state imaging element according to claim 1, wherein
the pixel signal includes a predetermined reset level and a signal level according to an exposure amount, and
each of the pixels includes:
first and second capacitive elements;
a pre-stage circuit that sequentially generates the reset level and the signal level and causes the first and second capacitive elements to hold the reset level and the signal level, respectively;
a first post-stage circuit that reads and outputs the reset level held in the first capacitive element; and
a second post-stage circuit that reads and outputs the signal level held in the second capacitive element.

8. The solid-state imaging element according to claim 1, wherein
the pixel signal includes a predetermined reset level and a signal level according to an exposure amount, and
each of the pixels includes:
first and second capacitive elements;
a pre-stage circuit that sequentially generates the reset level and the signal level and causes the first and second capacitive elements to hold the reset level and the signal level, respectively;
a selection circuit that sequentially performs control to connect one of the first and second capacitive elements to a predetermined post-stage node, control to disconnect both the first and second capacitive elements from the post-stage node, and control to connect another of the first and second capacitive elements to the post-stage node;
a post-stage reset transistor that initializes a level of the post-stage node when both the first and second capacitive elements are disconnected from the post-stage node; and
a post-stage circuit that sequentially reads the reset level and the signal level from the first and second capacitive elements via the post-stage node and outputs the reset level and the signal level.

9. An imaging device comprising:
a pixel array section in which a plurality of pixels each generating and holding an analog pixel signal is arranged in a two-dimensional grid pattern;
a plurality of integration circuits that time-integrates the pixel signal held in each of a predetermined number of pixels arranged in a vertical direction among the plurality of pixels and outputs an integration signal;
an analog-to-digital converter that adds the integration signal of each of the plurality of integration circuits to convert the added integration signal into a digital signal; and
an image recognition section that performs predetermined image recognition processing using the digital signal.

10. A method of controlling a solid-state imaging element, the method comprising:
a sample and hold procedure in which each of a plurality of pixels arranged in a two-dimensional grid pattern generates and holds an analog pixel signal;
an integration procedure in which a plurality of integration circuits time-integrates the pixel signal held in each of a predetermined number of pixels arranged in a vertical direction among the plurality of pixels and outputs an integration signal; and
an analog-to-digital conversion procedure of analog-adding the integration signal of each of the plurality of integration circuits to convert the analog-added integration signal into a digital signal.
